(19) United States
(12) Patent Application Publication
(10) Pub. No.: US 2023/0384788 A1
(43) Pub. Date: Nov. 30, 2023

(54) INFORMATION PROCESSING DEVICE, INFORMATION PROCESSING SYSTEM, INFORMATION PROCESSING METHOD, AND RECORDING MEDIUM STORING PROGRAM

(71) Applicants: Junki AOKI, Tokyo (JP); Ryota YAMASHINA, Tokyo (JP); KYUSHU UNIVERSITY, NATIONAL UNIVERSITY CORPORATION, Fukuoka (JP)

(72) Inventors: Junki AOKI, Fukuoka (JP); Ryota YAMASHINA, Kanagawa (JP); Ryo KURAZUME, Fukuoka (JP)

(73) Assignees: Ricoh Company, Ltd., Tokyo (JP); KYUSHU UNIVERSITY, NATIONAL UNIVERSITY CORPORATION, Fukuoka (JP)

(21) Appl. No.: 18/324,476

(22) Filed: May 26, 2023

(30) Foreign Application Priority Data
May 31, 2022 (JP) 2022-088966
Oct. 28, 2022 (JP) 2022-173809
May 24, 2023 (JP) 2023-085484

(51) Int. Cl. G05D 1/00; G05D 1/02

(52) U.S. Cl. CPC G05D 1/005; G05D 1/0212; G05D 1/0038

(57) ABSTRACT

An information processing device, for communicating with an autonomous mobile device, includes circuitry and a memory storing computer-executable instructions that cause the circuitry to execute transmitting an operation command of an operator of the autonomous mobile device to the autonomous mobile device existing in a real world and a virtual mobile device simulating the autonomous mobile device and existing in a virtual world simulating the real world, and switching from a real mode to a virtual mode when the autonomous mobile device detects an inhibitor inhibiting operability of the operator to operate the autonomous mobile device, the real mode providing the operator with sensory feedback corresponding to an autonomous movement of the autonomous mobile device in the real world, and the virtual mode providing the operator with sensory feedback corresponding to a movement according to the operation command of the virtual mobile device in the virtual world.

### CROSS-REFERENCE TO RELATED APPLICATION

The present application is based on and claims priority under 35 U.S.C. § 119 to Japanese Patent Application No. 2022-088966, filed on May 31, 2022, Japanese Patent Application No. 2022-173809, filed on Oct. 28, 2022, and Japanese Patent Application No. 2023-85484, filed on May 24, 2023. The contents of these three applications are incorporated herein by reference in their entirety.

### BACKGROUND OF THE INVENTION

### 1. Field of the Invention

The present disclosure relates to an information processing device, an information processing system, an information processing method, and a recording medium storing programs.

### 2. Description of the Related Art

An autonomous mobile device such as an autonomous mobile robot (AMR) has a global autonomous movement function and a local autonomous movement function. The device uses the global autonomous movement function to perform Simultaneous Localization and Mapping (SLAM) and calculate a global moving route to a target position, thereby enabling autonomous movement. The device uses the local autonomous movement function to detect a person, an obstacle, or the like, and calculate a local moving route to a sub-target position, thereby enabling autonomous avoidance of the person, the obstacle, or the like.

Meanwhile, there is a remote-controlled mobile robot on which a camera, a microphone, or the like is mounted. An operator remotely controls the mobile robot while checking an image of the camera, sound from the microphone, or the like on a personal computer (PC) or the like. Some remote-controlled mobile robots perform shared control (SC) for supplementarily correcting movement in accordance with an operation instruction. When a person, an obstacle, or the like is detected, with shared control, the operator and the mobile robot cooperate with each other to avoid the person, the obstacle, or the like, thereby realizing safe movement.

In a remote-controlled autonomous mobile robot, when there is a difference between an operation instruction and actual autonomous movement of the robot ascertained from feedback from the robot's camera or the like, the operator may feel discomfort. For example, if the autonomous mobile device autonomously avoids an obstacle when the operator cannot perceive the obstacle from the video of the camera, the operator cannot intuitively understand why the autonomous mobile device does not move as instructed. As a result, a mismatch occurs between the autonomous movement of the robot and the expected action of the robot by the operation of the operator, resulting in a feeling of discomfort. Now, there is technology for visualizing a future trajectory or a target position and a target posture of a robot using augmented reality (AR) technology (for example, Non-Patent Document 1).

Non-Patent Document 1 describes visualizing a future trajectory or a target position and a target posture of an autonomous movement of a robot. Although the possibility that the operator feels uncomfortable with the action of the robot is reduced due to the visualized future trajectory of the robot or the like, the visualization technique does not ensure that the robot moves as intended by the operator.

### RELATED-ART DOCUMENT

### Non-Patent Document

[Non-Patent Document 1] C. Brooks et al., “Visualization of Intended Assistance for Acceptance of Shared Control”, IEEE/RSJ International Conference on Intelligent Robots and Systems (IROS), pp. 11425 to 11430, 2020.

### SUMMARY OF THE INVENTION

According to an embodiment of the present disclosure, there is provided an information processing device, for communicating with an autonomous mobile device, including circuitry and a memory storing computer-executable instructions that cause the circuitry to execute transmitting an operation command of an operator of the autonomous mobile device to the autonomous mobile device existing in a real world and a virtual mobile device simulating the autonomous mobile device and existing in a virtual world simulating the real world and switching from a real mode to a virtual mode when the autonomous mobile device detects an inhibitor inhibiting operability of the operator to operate the autonomous mobile device, the real mode providing the operator with sensory feedback corresponding to an autonomous movement of the autonomous mobile device in the real world, and the virtual mode providing the operator with sensory feedback corresponding to a movement according to the operation command of the virtual mobile device in the virtual world.

### BRIEF DESCRIPTION OF THE DRAWINGS

FIG. 1 is a diagram illustrating a system configuration example of an information processing system according to a first embodiment;

FIG. 2 is a diagram illustrating a hardware configuration example of an autonomous mobile device according to the first embodiment;

FIG. 3 is a diagram illustrating a hardware configuration example of an information processing device according to the first embodiment;

FIG. 4 is a diagram illustrating an example of overall operation of the information processing system according to the first embodiment;

FIGS. 5A and 5B are diagrams illustrating positional relationship between the autonomous mobile device and a virtual mobile device according to the first embodiment;

FIG. 6 is a diagram illustrating an example of a user interface of the information processing device according to the first embodiment;

FIG. 7 is a diagram illustrating a functional configuration example of the information processing system according to the first embodiment;

FIG. 8 is a diagram illustrating an example of an initialization sequence according to the first embodiment;

FIG. 9 is a diagram illustrating a real mode sequence example according to the first embodiment;

FIG. 10 is a diagram illustrating a virtual mode sequence example according to the first embodiment;

FIG. 11 is a diagram illustrating an autonomous movement enabling sequence example according to the first embodiment;

FIG. 12 is a diagram illustrating a modified example of the functional configuration of the information processing system according to the first embodiment;

FIG. 13 is a diagram illustrating a modified example of the virtual mode sequence according to the first embodiment;

FIG. 14 is a diagram illustrating a system configuration example of an information processing system according to a second embodiment;

FIG. 15 is a diagram illustrating a hardware configuration example of the information processing system according to the second embodiment; and

FIG. 16 is a diagram illustrating an example of a user interface of the information processing device according to the second embodiment.

### DESCRIPTION OF THE EMBODIMENTS

The present disclosure has an object to provide a technique for allowing an operator who remotely operates an autonomous mobile device to perform a desired operation without feeling uncomfortable with feedback corresponding to the operation.

Hereinafter, embodiments of the present disclosure will be described in detail with reference to the drawings.

### First Embodiment

Hereinafter, a system configuration of an information processing system 100 will be described.

### <System Configuration>

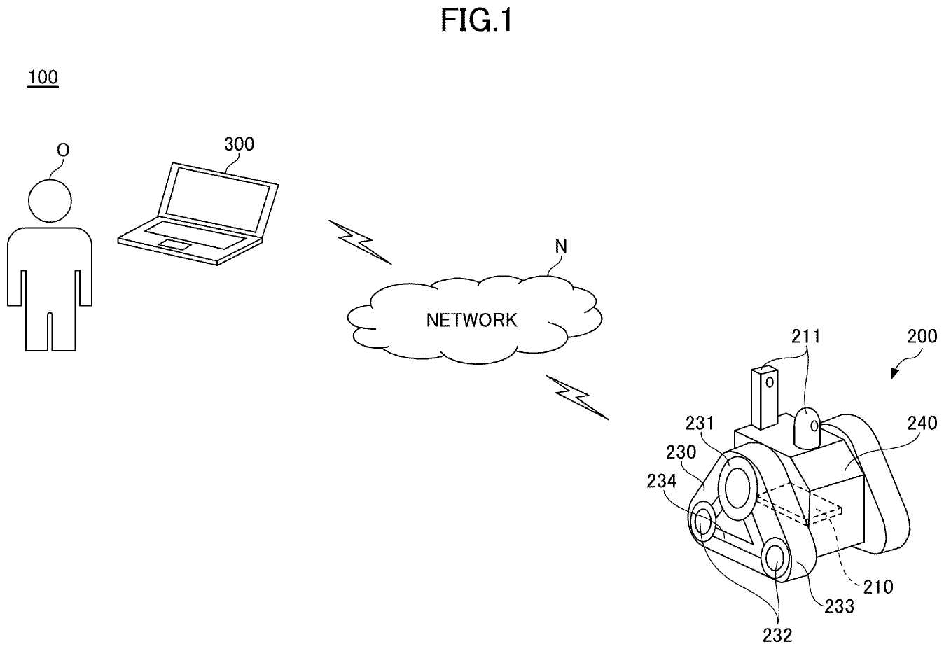

FIG. 1 is a diagram illustrating a system configuration example of the information processing system 100 according to the present embodiment. The information processing system 100 includes an autonomous mobile device 200 and an information processing device 300 that is communicably connected to the autonomous mobile device 200 and operates the autonomous mobile device 200.

The autonomous mobile device 200 is, for example, an autonomous mobile robot (AMR). The autonomous mobile device 200 has a global autonomous mobile function and a local autonomous mobile function. The autonomous mobile device 200 performs, for example, SLAM (Simultaneous Localization and Mapping) to calculate a global moving route to a target position, and autonomously moves thereto. Further, if the autonomous mobile device 200 detects a person, an obstacle, or the like, for example, on the global moving route, the device determines a local moving route to a sub-target position and autonomously avoids the person, the obstacle, or the like.

The autonomous mobile device 200 is a remote-controlled mobile robot that is remotely controlled by an operator O using the information processing device 300. The autonomous mobile device 200 performs SC (shared control) for supplementarily correcting the movement in accordance with the operation instruction from the operator O. The operator O and the autonomous mobile device 200 share one task and cooperate to control the autonomous mobile device 200. The autonomous mobile device 200 is communicably connected to the information processing device 300 via a network N.

The information processing device 300 is, for example, a personal computer (PC). The information processing device 300 is not limited to a PC if it is a device having a communication function. The information processing device 300 may be an information processing device such as a tablet terminal, a smartphone, or a personal digital assistant (PDA).

The information processing device 300 transmits an operation command (for example, a forward movement command, a backward movement command, a right pivot-turn command, a left pivot-turn command, an acceleration command, a deceleration command, or the like) obtained by processing the operation instruction sent from the operator O to the autonomous mobile device 200. While autonomously moving along the global moving route, the autonomous mobile device 200 supplementarily corrects the movement in accordance with the operation command. For example, the autonomous mobile device 200 detects a person, an obstacle, or the like, determines a local moving route that avoids the person, the obstacle, or the like, and autonomously moves along the local moving route to correct the movement according to the operation command. A person, an obstacle, or the like is an example of an inhibitor that inhibits the operability of the autonomous mobile device 200 of the operator O. A communication delay (time lag) or the like between the information processing device 300 and the autonomous mobile device 200 is another example of such an inhibitor.

### <Hardware Configuration>

Hereinafter, a hardware configuration of the information processing system 100 will be described.

### <<Autonomous Mobile Device>>

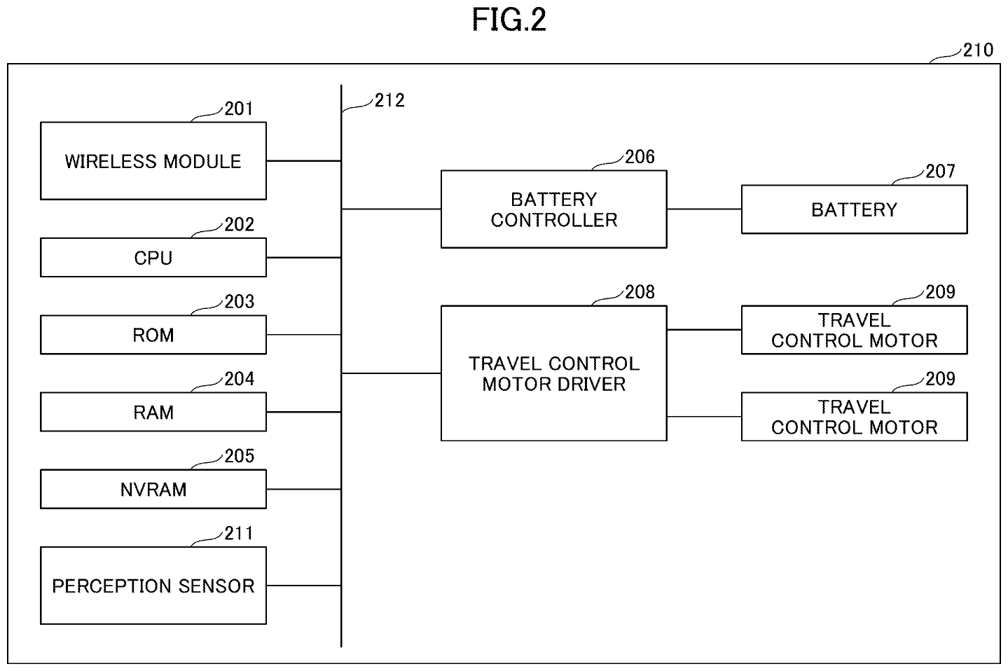

First, a hardware configuration of the autonomous mobile device 200 will be described with reference to FIGS. 1 and 2. FIG. 2 is a diagram illustrating a hardware configuration example of the autonomous mobile device 200 according to the present embodiment.

As illustrated in FIG. 1, the autonomous mobile device 200 includes a main body 240, a pair of traveling units 230, and a control unit 210.

The main body 240 is a housing formed of metal or the like, and incorporates the control unit 210. The main body 240 includes two side surfaces that connect the pair of traveling units 230.

The traveling unit 230 is a moving mechanism connected to one of the side surfaces of the main body 240. The traveling unit 230 is, for example, a crawler-type moving mechanism, and enables the autonomous mobile device 200 to move in all directions and move on rough terrain. The traveling unit 230 includes a driving wheel 231, two rollers 232, a crawler 233, and a support 234.

The driving wheel 231 is located above the two rollers 232. The driving wheel 231 is driven to rotate by a travel control motor 209, which will be described later, and transmits a driving force to the crawler 233. The two rollers 232 are located below the driving wheel 231. The roller 232 rotates in response to the movement of the crawler 233. The crawler 233 is a belt formed by connecting a plurality of track shoes formed of metal, rubber, or the like. The crawler 233 winds around the driving wheel 231 and the two rollers 232. The support 234 rotatably supports the driving wheel 231 and the two rollers 232, and connects the traveling unit 230 to the main body 240.

The traveling unit 230 is not limited to the crawler-type if it is a device having a moving function. The traveling unit 230 may be, for example, a traveling mechanism of a wheel-type, a leg-type, a special-type, or an arbitrary combination of these types.

The control unit 210 controls the overall movement of the autonomous mobile device 200. The control unit 210 provides wireless communication functions, battery functions, travel control functions, sensory functions, and the like. The wireless function enables communication with the information processing device 300. The battery function provides power to the autonomous mobile device 200. The travel control function enables travel control of the autonomous mobile device 200. The sensory function provides sensations such as sight, hearing, balance, and force to the autonomous mobile device 200.

As illustrated in FIG. 2, the control unit 210 includes a wireless module 201. Further, the control unit 210 includes a central processing unit (CPU) 202, a read only memory (ROM) 203, and a random access memory (RAM) 204. Alternatively, the control unit 210 may include a programmable logic controller (PLC). Further, the control unit 210 includes a nonvolatile random access memory (NVRAM) 205.

The control unit 210 further includes a battery controller 206 and a battery 207. The control unit 210 also includes a travel control motor driver 208 and two travel control motors 209. Furthermore, the control unit 210 includes a perception sensor 211 and a bus 212.

The wireless module 201 includes an antenna, a transmission/reception circuit, a digital-to-analog (D/A) converter, an analog-to-digital (A/D) converter, and the like. The wireless module 201 is communicably connected to the information processing device 300 via the network N. The wireless module 201 is communicably connected to an external device such as a cloud server or a PC outside the information processing system 100 via the network N, and enables various programs to be downloaded from the external device and installed.

The CPU 202 controls the overall movement of the autonomous mobile device 200. The ROM 203 stores a program used for driving the CPU 202, such as an initial program loader (IPL). The RAM 204 is used as a storage area for loading a program or as a work area for the loaded program. The NVRAM 205 is an example of a nonvolatile memory that stores various programs and various kinds of data used by the programs. The CPU 202 realizes various functions by executing various programs loaded into the RAM 204.

The battery controller 206 controls charging and discharging of the battery 207 in response to a CPU 202 command. The battery 207 is a secondary battery such as a lithium ion battery, for example. The battery 207 is charged in response to a command from the battery controller 206, and supplies power to various hardware components in response to a command from the battery controller 206.

The travel control motor driver 208 generates a motor drive signal in accordance with a movement command (a position command, a speed command, and the like) of the CPU 202, and supplies the motor drive signal to the two travel control motors 209. The travel control motor 209 rotates in response to the motor drive signal, and transmits a rotational force to the driving wheel 231. In order to increase the transmission efficiency, the travel control motor 209 may be, for example, an in-wheel motor built in the driving wheel 231. Each one of the two travel control motors 209 drives the corresponding one of the traveling units 230.

When the two travel control motors 209 rotate in the positive direction, the autonomous mobile device 200 moves forward. When the two travel control motors 209 rotate in the negative direction, the autonomous mobile device 200 moves backward. When one of the travel control motors 209 stops and the other travel control motor 209 rotates in the positive direction or the negative direction, the autonomous mobile device 200 pivot-turns. When one travel control motor 209 rotates in the positive direction and the other travel control motor 209 rotates in the negative direction, the autonomous mobile device 200 spin-turns.

The travel control motor 209 has a built-in motor encoder that detects a rotation angle, a rotation speed, and the like of the travel control motor 209. The CPU 202 has an odometry function for estimating the position of the autonomous mobile device 200 based on the rotation angle and the rotation speed detected by the motor encoder. The position is, for example, a position in three axis (X-axis, Y-axis, and Z-axis) directions of an orthogonal coordinate system.

The perception sensor 211 includes a camera and a light detection and ranging (LiDAR) sensor. The camera and the LiDAR are examples of a visual sensor. The CPU 202 estimates the position of the autonomous mobile device 200 based on the three-dimensional point cloud data detected from moment to moment by the LiDAR. Alternatively, the perception sensor 211 may include a time of flight (TOF) sensor instead of the LiDAR. The CPU 202 then estimates the position of the autonomous mobile device 200 based on the three-dimensional point cloud data detected from moment to moment by the TOF sensor.

The perception sensor 211 may further include a micro electro mechanical systems (MEMS) sensor, an inertial measurement unit (IMU), or the like. The MEMS sensor or the IMU detects acceleration in three axis directions of the orthogonal coordinate system and angular velocity around the three axes of the orthogonal coordinate system. A MEMS sensor or IMU is an example of an equilibrium sensor. The CPU 202 may estimate the position of the autonomous mobile device 200 based on acceleration or the like detected from moment to moment by the MEMS sensor or the IMU.

The perception sensor 211 is not limited to a visual sensor and an equilibrium sensor. For example, the perception sensor 211 may further include a force sensor, a tactile sensor, an auditory sensor, or any combination of these sensors.

The bus 212 electrically connects various types of hardware. The bus 212 includes various signal lines such as a data line, an address line, and a control line. The bus 212 is used for transmission and reception of data between various types of hardware, control, and the like.

### <<Information Processing Device>>

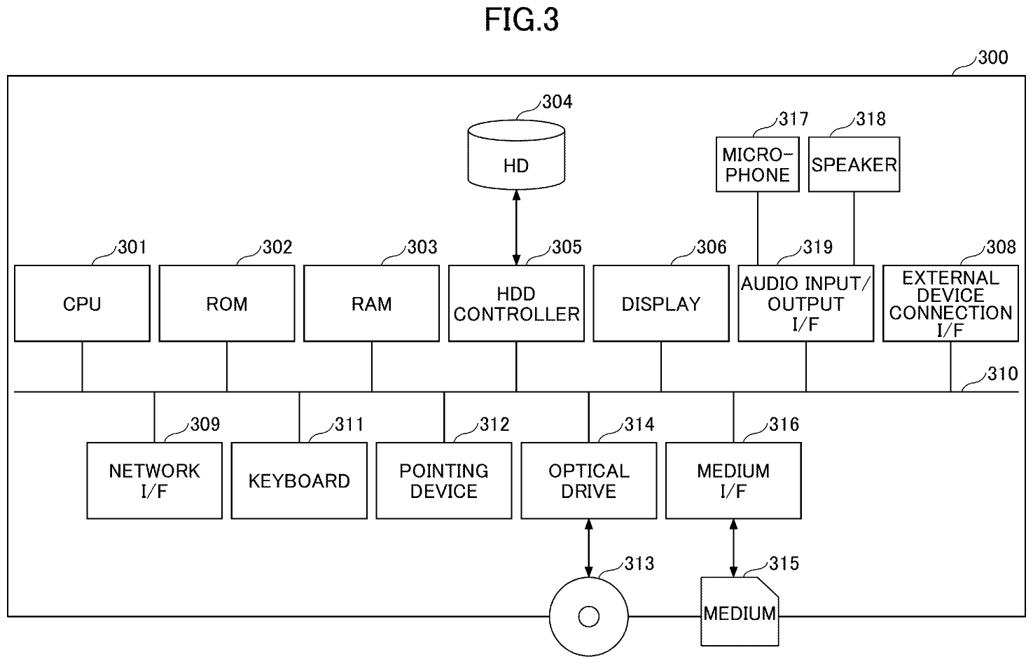

Next, a hardware configuration example of the information processing device 300 (computer) will be described with reference to FIG. 3. FIG. 3 is a diagram illustrating a hardware configuration example of the information processing device 300 according to the present embodiment.

The information processing device 300 includes a CPU 301, a ROM 302, a RAM 303, an HD 304, and an HDD controller 305. The information processing device 300 also includes a display 306, an external device connection I/F 308, a network I/F 309, and a bus 310. The information processing device further includes a keyboard 311, a pointing device 312, an optical drive 314, and a medium I/F 316.

The CPU 301 controls the overall operation of the information processing device. The ROM 302 stores a program used for driving the CPU 301 such as the IPL. The RAM 303 is used as a work area for the CPU 301. The HD 304 stores various kinds of information such as programs. The HD 304 is an example of non-volatile storage. The HDD controller 305 controls reading or writing of various kinds of information from or to the HD 304 under the control of the CPU 301.

The display 306 displays various types of information such as a cursor, a menu, a window, characters, or an image. The external device connection I/F 308 is an interface for connecting various external devices to the information processing device 300. The external device includes, for example, a universal serial bus (USB) memory, a printer, and the like. The network I/F 309 is an interface for performing data transmission via a network.

The network I/F 309 is communicatively connected to the autonomous mobile device 200 via the network N. The network I/F 309 is communicably connected to an external device such as a cloud server or a personal computer outside the information processing system 100 via the network N, and enables various programs to be downloaded from the external device and installed. The bus 310 electrically connects various types of hardware such as the CPU 301. The bus 310 includes an address bus, a data bus, and the like.

The keyboard 311 is an example of an operation part of the autonomous mobile device 200 including a plurality of keys for inputting characters, numerical values, various instructions, and the like. The pointing device 312 is an example of an operation part of the autonomous mobile device 200 that performs selection or execution of various instructions, selection of a processing target, movement of a cursor, and the like.

The optical drive 314 controls reading or writing of various data from or to a removable recording medium 313. The recording medium 313 includes a CD-R, a CD-RW, a DVD-R, a DVD-RW, or the like. The medium I/F 316 controls reading or writing from or to a medium 315 such as a flash memory. The medium 315 is an example of a nonvolatile memory.

### Overall Operation Example of Information Processing System

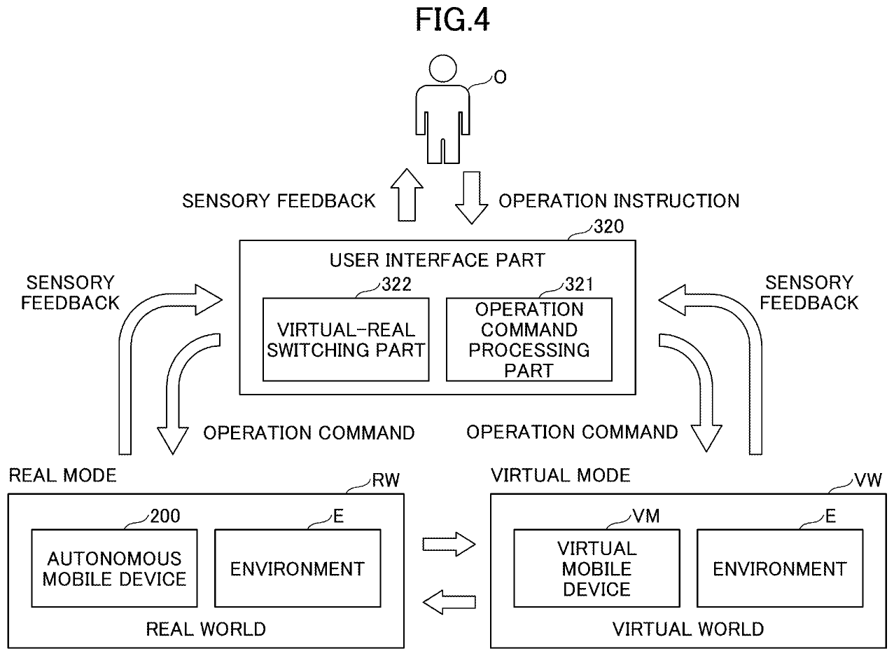

Hereinafter, an overall operation of the information processing system 100 according to the present embodiment will be described. FIG. 4 is a diagram illustrating the overall operation of the information processing system 100 according to the present embodiment.

The information processing device 300 has a processing mode switching function of switching between a real mode and a virtual mode. The real mode is a processing mode in which sensory feedback corresponding to the movement of the autonomous mobile device 200 present in a real world RW is provided to the operator O. The virtual mode is a processing mode for providing the operator O with sensory feedback corresponding to the movement of a virtual mobile device VM that is present in a virtual world VW that simulates the real world RW and simulates the autonomous mobile device 200.

Note that the virtual world VW is a three-dimensional model simulating the real world RW, and the virtual mobile device VM is a three-dimensional model simulating the autonomous mobile device 200. The three-dimensional model of the virtual world VW is constructed in advance or in real time from three-dimensional point cloud data of the real world RW detected by the LiDAR or from image data acquired by a camera sensor. In this embodiment, the three-dimensional model of the virtual mobile device VM is constructed in advance from the three-dimensional point cloud data of the autonomous mobile device 200 detected by the LiDAR or the like.

The sensory feedback includes any sensory feedback perceived from the real world RW or the virtual world VW. For example, the sensory feedback includes visual feedback, tactile feedback, force feedback, auditory feedback, balance feedback, or any combination of these sensory feedback. The real image of the real world RW or the virtual image of the virtual world VW is an example of visual feedback. The real image is acquired from a video of the real world detected by a camera or the like, and the virtual image is acquired from a three-dimensional model of the virtual world VW. The three-dimensional model may be a model explicitly generated from the three-dimensional point cloud data, or may be a model implicitly generated by a neural network or the like.

The information processing device 300 includes a user interface part 320. The user interface part 320 includes an operation command processing part 321 and a virtual-real switching part 322. The various functions of the user interface part 320 are realized by processes that one or more programs installed in the information processing device 300 cause a processor such as the CPU 301 or the like to execute.

The operation command processing part 321 transmits an operation command obtained by processing the operation instruction from the operator O to the autonomous mobile device 200 or the virtual mobile device VM. The autonomous mobile device 200 moves under an environment E of the real world RW in response to the operation command, and provides sensory feedback of the real world RW to the user interface part 320. The virtual mobile device VM moves under an environment E of the virtual world VW in response to the operation command, and provides sensory feedback of the virtual world VW to the user interface part 320.

The user interface part 320 provides the operator O with the sensory feedback of the real world RW or the virtual world VW. The operator O gives an operation instruction to the autonomous mobile device 200 or the virtual mobile device VM while confirming the sensory feedback via the user interface part 320. The operation command processing part 321 transmits an operation command obtained by processing the operation instruction to the autonomous mobile device 200 or the virtual mobile device VM.

When the autonomous mobile device 200 detects an inhibitor (a person, an obstacle, or the like) that inhibits the operability of the autonomous mobile device 200 of the operator O, the virtual-real switching part 322 switches from the real mode to the virtual mode.

After switching from the real mode to the virtual mode, the operation command processing part 321 transmits an operation command obtained by processing the operation instruction from the operator O to the virtual mobile device VM. The virtual mobile device VM moves under the environment E of the virtual world VW in response to the operation command, and provides sensory feedback of the virtual world VW to the user interface part 320. The user interface part 320 provides the sensory feedback of the virtual world VW to the operator O. The operator O gives an operation instruction to the virtual mobile device VM while confirming the sensory feedback via the user interface part 320, and the operation command processing part 321 transmits an operation command obtained by processing the operation instruction to the virtual mobile device VM.

After switching from the real mode to the virtual mode, if the autonomous mobile device 200 avoids the inhibitor (a person, an obstacle, or the like), the virtual-real switching part 322 switches back from the virtual mode to the real mode.

The operation command processing part 321 transmits an operation command to the autonomous mobile device 200 in the real mode. The autonomous mobile device 200 moves under the environment E of the real world RW in response to the operation command, and provides sensory feedback of the real world RW to the user interface part 320. The user interface part 320 provides the sensory feedback of the real world RW to the operator O. The operator O gives an operation instruction to the autonomous mobile device 200 while confirming the sensory feedback via the user interface part 320, and the operation command processing part 321 transmits an operation command obtained by processing the operation instruction to the autonomous mobile device 200.

Thereafter, the user interface part 320 repeats state transition between the real mode and the virtual mode in accordance with the detection result of the autonomous mobile device 200 detecting an inhibitor OB (a person, an obstacle, or the like) that inhibits the operability of the autonomous mobile device 200 of the operator O.

### <Positional Relationship Between Autonomous Mobile Device and Virtual Mobile Device>

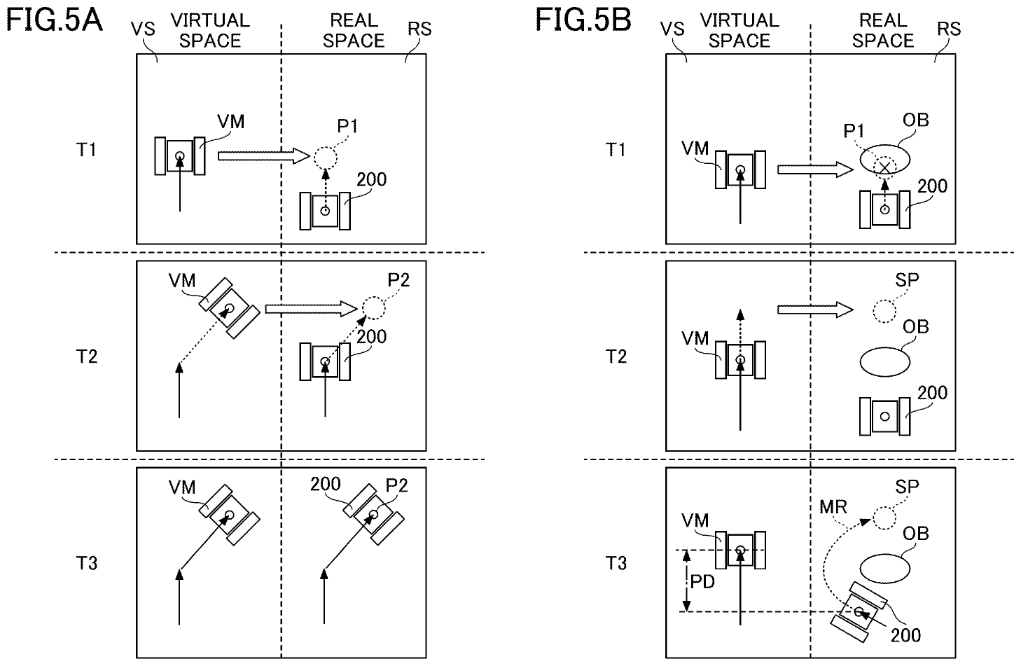

Hereinafter, a positional relationship between the autonomous mobile device 200 and the virtual mobile device VM will be described. FIG. 5 is a diagram illustrating the positional relationship between the autonomous mobile device 200 and the virtual mobile device VM according to the present embodiment. In the drawing, a solid-line arrow indicates a past trajectory, and a broken-line arrow indicates a future trajectory.

FIG. 5A illustrates states in which the autonomous mobile device 200 present in a real space RS autonomously moves following the virtual mobile device VM present in a virtual space VS. At a first time T1, the autonomous mobile device 200 autonomously moves following the movement of the virtual mobile device VM moving toward a first position P1. At a second time T2, the virtual mobile device VM stops at a second position P2, and the autonomous mobile device 200 autonomously moves following the movement of the virtual mobile device VM moving toward the second position P2. At a third time T3, the autonomous mobile device 200 catches up with the virtual mobile device VM, and stops at the second position P2.

FIG. 5B illustrates states in which the autonomous mobile device 200 detects an inhibitor OB such as a person or an obstacle, and autonomously avoids the inhibitor OB. At a first time T1, the autonomous mobile device 200 detects an inhibitor OB (a person, an obstacle, or the like) that inhibits the operability of the autonomous mobile device 200 of the operator O. At a second time T2, an effective point on the future trajectory of the virtual mobile device VM is set as a sub-target position SP of the autonomous mobile device 200. At a third time T3, the autonomous mobile device 200 determines a local moving route MR for autonomously avoiding the inhibitor OB according to the sub-target position SP, and moves to the sub-target position SP along the local moving route MR.

As illustrated at the first time T1, when the inhibitor OB is present at the position P1 of the virtual mobile device VM in the real space RS, since the virtual mobile device VM passes through the inhibitor OB in the virtual world VW, the operator O is not aware of the inhibitor OB. Note that when the three-dimensional model of the virtual world VW is constructed in advance, the inhibitor OB itself does not exist in the virtual world VW. The autonomous mobile device 200 is therefore required to autonomously avoid the inhibitor OB.

On the other hand, when the inhibitor OB is present on the future trajectory of the virtual mobile device VM in the real space RS, since the inhibitor OB is present in front of the virtual mobile device VM in the virtual mode, the operator O notices the inhibitor OB. As a result, it is not required to be in the virtual mode, and in the real mode, the operator O may operate the autonomous mobile device 200 to avoid the inhibitor OB, or the autonomous mobile device 200 may autonomously avoid the inhibitor OB.

Further, as illustrated at the third time T3, when the virtual mobile device VM moves straight and the autonomous mobile device 200 autonomously avoids the inhibitor OB, the virtual mobile device VM could move ahead of the autonomous mobile device 200. Therefore, when the user interface part 320 switches from the virtual mode to the real mode, the operator O could feel discomfort. Therefore, it is required to reduce the speed of the virtual mobile device VM.

### <User Interface>

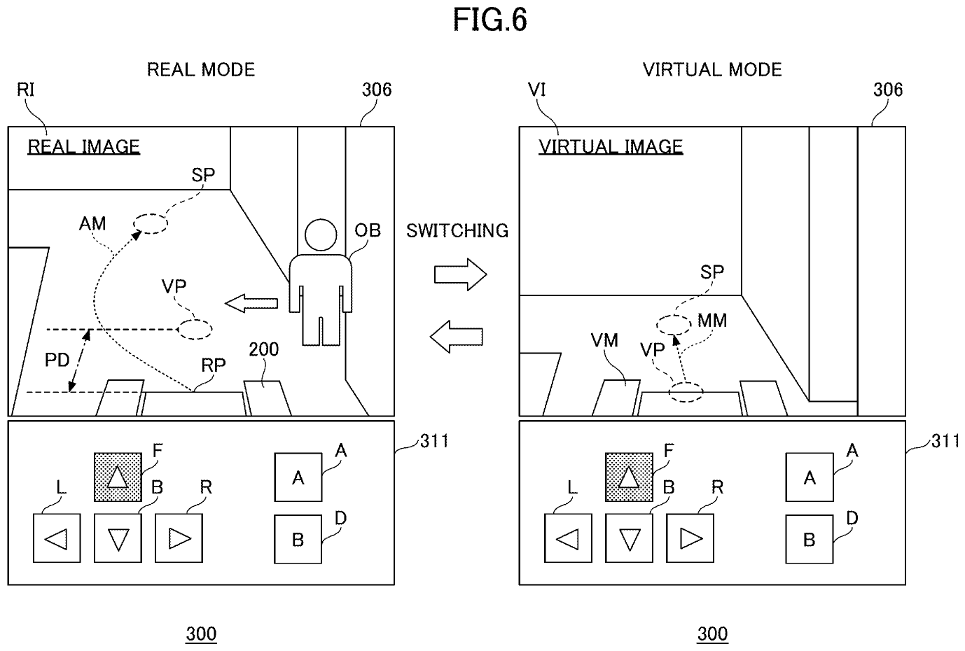

The user interface of the information processing device 300 will be described below. FIG. 6 is a diagram illustrating a user interface example of the information processing device 300 according to the present embodiment.

The user interface part 320 assigns operation instructions (travel instructions) to the autonomous mobile device 200 or the virtual mobile device VM to various keys of the keyboard 311 of the information processing device 300. For example, the user interface part 320 assigns a forward instruction to an up arrow key F, and a backward instruction to a down arrow key B. The user interface part 320 further assigns a right pivot-turn to a right arrow key R, and a left pivot-turn to a left arrow key L. The user interface part 320 further assigns an acceleration instruction to an A-key A, and a deceleration instruction to a B-key D.

When the autonomous mobile device 200 autonomously moves along the global moving route, the operator O may instruct acceleration or deceleration, and thus an acceleration instruction and a deceleration instruction may be assigned to arbitrary keys in the user interface part 320. Further, the keyboard 311 may be a software keyboard instead of a hardware keyboard.

In the real mode, the user interface part 320 displays a real image RI that is sensory feedback of the real world RW on the display 306 of the information processing device 300. Similarly, in the virtual mode, the user interface part 320 displays a virtual image VI that is the sensory feedback of the virtual world VW on the display 306 of the information processing device 300.

When the autonomous mobile device 200 detects an inhibitor OB (for example, a moving person) using the perception sensor 211, the user interface part 320 switches from the real mode to the virtual mode. In the real mode, the operator O perceives an autonomous movement AM of the autonomous mobile device 200 in the real world RW, whereas in the virtual mode the operator O perceives a manual movement MM of the virtual mobile device VM in the virtual world VW. Therefore, in the virtual mode, the operator O does not feel that the autonomous mobile device 200 performs the autonomous movement AM different from the manual movement MM according to the instruction of the operator O.

After the user interface part 320 switches from the real mode to the virtual mode, the user interface part 320 automatically decelerates the position change speed in the manual movement MM of the virtual mobile device VM so that a position deviation PD between the autonomous mobile device 200 and the virtual mobile device VM becomes small.

When the inhibitor OB is present at a position VP of the virtual mobile device VM in the real world RW, the operator O is not aware of the inhibitor OB in the virtual mode. Therefore, the information processing device 300 requests the autonomous mobile device 200 to perform autonomous movement for moving to the sub-target position SP while autonomously avoiding the inhibitor OB.

The autonomous mobile device 200 determines the local moving route from a position RP of the autonomous mobile device 200 to the sub-target position SP to avoid the inhibitor OB, and performs the autonomous movement AM along the moving route to move to the sub-target position SP. When the autonomous mobile device 200 avoids the inhibitor OB and reaches the sub-target position SP, the information processing device 300 returns from the virtual mode to the real mode.

### <Functional Configuration>

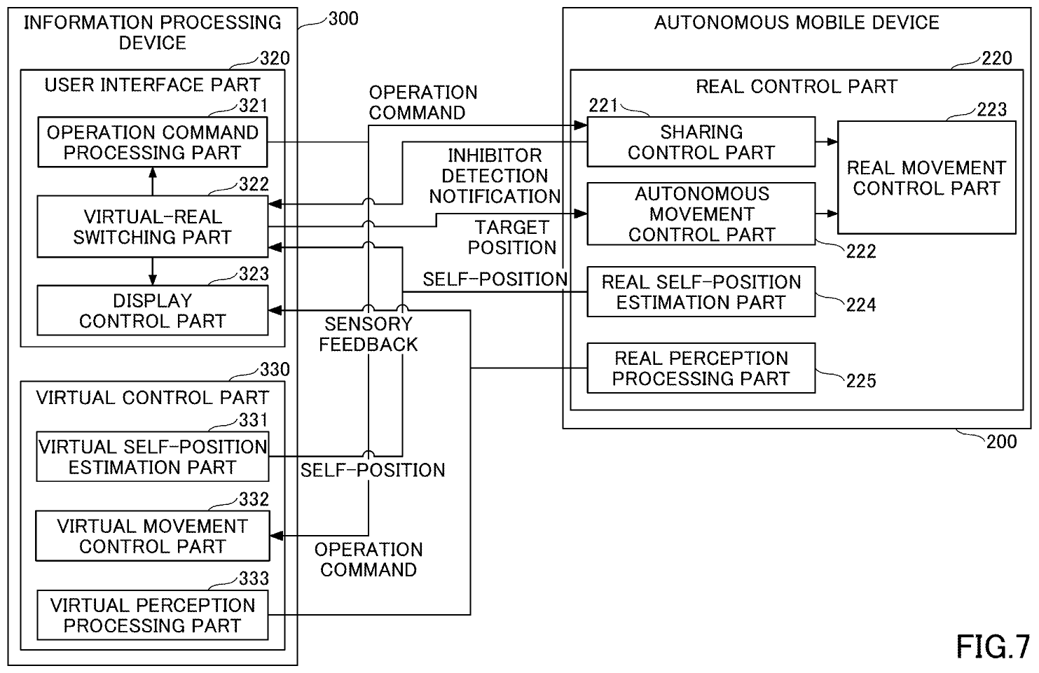

Hereinafter, a functional configuration of the information processing system 100 will be described. FIG. 7 is a diagram illustrating a functional configuration example of the information processing system 100 according to the present embodiment.

The autonomous mobile device 200 includes a real control part 220. The real control part 220 controls the actual movement of the autonomous mobile device 200 in the real world RW. The real control part 220 includes a sharing control part 221, an autonomous movement control part 222, a real movement control part 223, a real self-position estimation part 224, and a real perception processing part 225. At least a part of the functions of the autonomous mobile device 200 may be assigned to the information processing device 300 or may be distributed to another device outside the information processing system 100.

Various functions of the real control part 220 are realized by processes that one or more programs installed in the autonomous mobile device 200 (computer) cause a processor such as the CPU 202 or the like to execute. For example, the sharing control part 221, the autonomous movement control part 222, the real movement control part 223, the real self-position estimation part 224, and the real perception processing part 225 are configured as program modules.

The information processing device 300 includes the user interface part 320 and the virtual control part 330. The user interface part 320 receives an operation instruction from the operator O, and provides sensory feedback to the operator O. The user interface part 320 includes the operation command processing part 321, the virtual-real switching part 322, and a display control part 323.

The virtual control part 330 controls the movement of the virtual mobile device VM in the virtual world VW. The virtual control part 330 includes a virtual self-position estimation part 331, a virtual movement control part 332, and a virtual perception processing part 333. At least a part of the functions of the information processing device 300 may be assigned to the autonomous mobile device 200 or may be distributed to another apparatus outside the information processing system 100.

Various functions of the user interface part 320 and the virtual control part 330 are realized by processes that one or more programs installed in the information processing device 300 (computer) cause a processor such as the CPU 301 or the like to execute. For example, the operation command processing part 321, the virtual-real switching part 322, the display control part 323, the virtual self-position estimation part 331, the virtual movement control part 332, and the virtual perception processing part 333 are configured as program modules.

The sharing control part 221 has an SC (sharing control) function for supplementarily correcting the movement of the autonomous mobile device 200 in accordance with the operation command of the operator O. The sharing control part 221 detects an inhibitor OB (a person, an obstacle, or the like) using the perception sensor 211. When the autonomous mobile device 200 includes, for example, a LiDAR as the perception sensor 211, the sharing control part 221 detects the presence or absence of an obstacle based on, for example, a distance to an object present in a traveling direction of the autonomous mobile device 200. When there is no inhibitor OB, the sharing control part 221 transmits a movement command (position command or the like) obtained by processing the operation command from the operation command processing part 321 to the real movement control part 223. When an inhibitor OB is present, the sharing control part 221 sends an inhibitor detection notification to the virtual-real switching part 322 to autonomously avoid the inhibitor OB.

When the sharing control part 221 detects that the autonomous movement of the autonomous mobile device 200 is inhibited by an inhibitor OB, the sharing control unit 221 may send the detection of the unavoidable inhibitor OB as an inhibitor detection notification to the virtual-real switching part 322. The unavoidable inhibitor OB includes at least any one of a person, an obstacle, and the like that inhibits the travel of the autonomous mobile device 200. For example, a moving person, a dynamic obstacle, an obstacle that moves even if it is a static obstacle, and the like are examples of the unavoidable inhibitor OB. Further, another inhibitor different from the previously detected inhibitor OB may inhibit the travel of the autonomous mobile device 200, so that, when another inhibitor is detected, the sharing control part 221 may send an inhibitor detection notification to the virtual-real switching part 322. The function of detecting the inhibitor OB may not be performed by the sharing control part 221 but may be performed by another functional part.

The autonomous movement control part 222 has the global autonomous movement function and the local autonomous movement function. The global autonomous movement function performs SLAM (Simultaneous Localization and Mapping), determines a global moving route to a target position, and enables autonomous movement along the global moving route. The local autonomous movement function determines a local moving route MR to a sub-target position SP and enables autonomous avoidance of the inhibitor OB.

In response to an autonomous movement request (target position) from the virtual-real switching part 322, the autonomous movement control part 222 transmits a movement command (position command or the like) to move along the global moving route to the target position to the real movement control part 223. Further, in response to an autonomous movement request (sub-target position SP) from the virtual-real switching part 322, the autonomous movement control part 222 sends a movement command (position command or the like) to move along the local moving route MR to the sub-target position SP to the real movement control part 223.

The real movement control part 223 processes a movement command (a position command or the like) from the sharing control part 221 or a movement command (a position command or the like) from the autonomous movement control part 222, and transmits a movement command (a position command, a speed command, and the like) to the travel control motor driver 208. The movement command includes a position command, a speed command, an acceleration command, and the like for the motor.

The real self-position estimation part 224 has a function of estimating the position RP of the autonomous mobile device 200 in the real world RW. The real self-position estimation part 224 estimates the position RP of the autonomous mobile device 200 using the perception sensor 211 such as a motor encoder, a LiDAR, a TOF sensor, a MEMS sensor, or an IMU. The position is, for example, a position in three axis (X-axis, Y-axis, and Z-axis) directions in an orthogonal coordinate system. In response to a self-position request from the virtual-real switching part 322, the real self-position estimation part 224 transmits the information of the position RP of the autonomous mobile device 200 to the virtual-real switching part 322.

The real perception processing part 225 sends the real image RI, which is the sensory feedback of the real world RW, to the display control part 323 from moment to moment using the perception sensor 211 (for example, a camera). The real perception processing part 225 may send the sensory feedback, including a sound, a force sense, a sense of equilibrium, and the like, of the real world RW to an output control unit from moment to moment using the perception sensor 211 (for example, a microphone, a force sensor, a MEMS sensor, and the like).

The operation command processing part 321 transmits an operation command obtained by processing an operation instruction from the operator O to the sharing control part 221. The operation command processing part 321 also transmits the operation command obtained by processing the operation instruction from the operator O to the virtual movement control part 332.

The virtual-real switching part 322 notifies the operation command processing part 321 and the display control part 323 of the processing mode. In response to an operation start instruction from the operator O, the virtual-real switching part 322 is initialized to the real mode. The virtual-real switching part 322 then receives the inhibitor detection notification from the sharing control part 221. The virtual-real switching part 322 switches from the real mode to the virtual mode in response to the inhibitor detection notification.

The virtual-real switching part 322 receives the position RP of the autonomous mobile device 200 from the real self-position estimation part 224, and obtains the position VP of the virtual mobile device VM from the virtual self-position estimation part 331. The virtual-real switching part 322 adjusts the position of the virtual mobile device VM so as to reduce the position deviation PD between the position RP of the autonomous mobile device 200 and the position VP of the virtual mobile device VM. For example, the virtual-real switching part 322 adjusts the speed of the virtual mobile device VM to automatically decelerate the position change speed of the virtual mobile device VM.

When the inhibitor OB is present at the position of the virtual mobile device VM in the real world RW, the virtual mobile device VM passes through the inhibitor OB in the virtual world VW, and thus the operator O is not aware of the inhibitor OB in the virtual mode. Therefore, the virtual-real switching part 322 determines that it is required to autonomously avoid the inhibitor, and requests the autonomous mobile device 200 to perform autonomous movement for autonomously avoiding the inhibitor OB.

On the other hand, when the inhibitor OB is present on the future trajectory of the virtual mobile device VM in the real world RW, since the inhibitor OB is present in front of the virtual mobile device VM in the virtual mode, the operator O is aware of the inhibitor OB in the virtual mode. Therefore, the virtual-real switching part 322 determines that the virtual mode is not required, and switches back the virtual mode to the real mode.

The display control part 323 displays the real image RI which is the sensory feedback of the real world RW or the virtual image VI which is the sensory feedback of the virtual world VW on the display 306 in accordance with a processing mode notification (real mode or virtual mode) of the virtual-real switching part 322.

The virtual self-position estimation part 331 has a function of estimating the position VP of the virtual mobile device VM in the virtual world VW. The virtual self-position estimation part 331 estimates the position VP of the virtual mobile device VM using, for example, an operation command (a forward movement command, a backward movement command, a right pivot-turn command, a left pivot-turn command, an acceleration command, a deceleration command, or the like). The virtual self-position estimation part 331 transmits the information of the position VP of the virtual mobile device VM to the virtual-real switching part 322 in response to a self-position request from the virtual-real switching part 322.

The virtual movement control part 332 receives an operation command from the operation command processing part 321. The virtual movement control part 332 controls the movement of the virtual mobile device VM in accordance with the operation command from the operation command processing part 321.

The virtual perception processing part 333 sends a virtual image VI, which is sensory feedback of the virtual world VW simulating the real world RW, to the display control part 323 from moment to moment using the perception sensor 211 (for example, LiDAR). Note that the virtual perception processing part 333 may send a virtual sound, a virtual force sense, a virtual sense of equilibrium, and the like which are sensory feedback of the virtual world VW simulating the real world RW to the output control unit from moment to moment using the perception sensor 211 (for example, a microphone, a force sensor, a MEMS sensor, and the like).

### <Sequence>

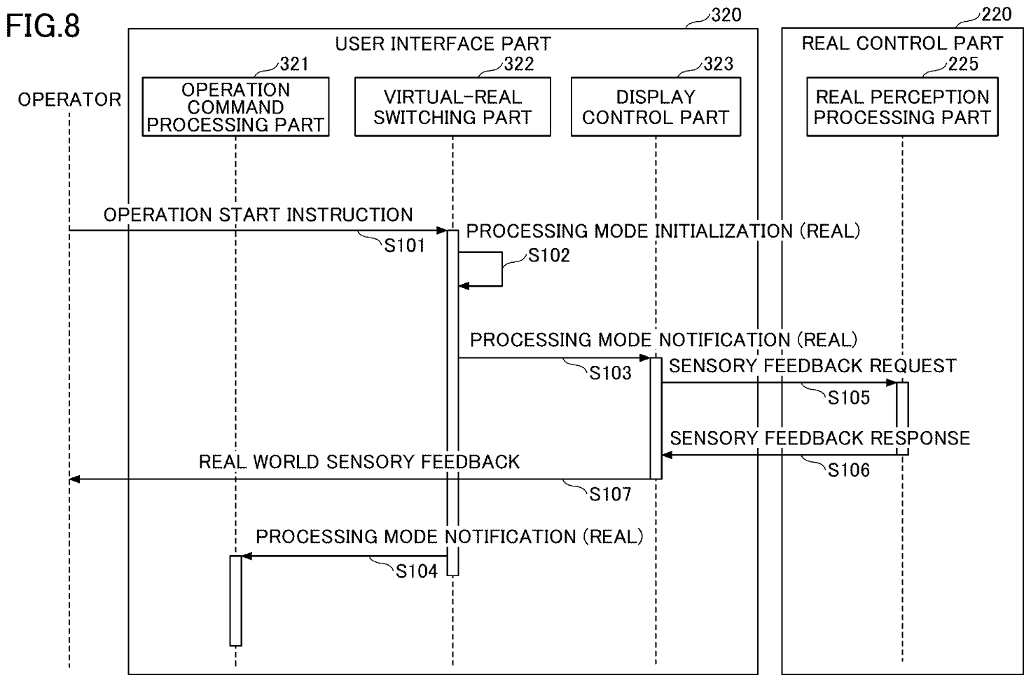

Next, a sequence illustrating a processing procedure of the information processing system 100 will be described with reference to FIGS. 8 to 11.

### <<Initialization Sequence>>

FIG. 8 is a diagram illustrating an example of an initialization sequence of the information processing system 100 according to the present embodiment. When the operator O gives an operation start instruction (step S101), the virtual-real switching part 322 initializes the processing mode to the real mode (step S102). The virtual-real switching part 322 notifies the display control part 323 of the processing mode (real mode) (step S103).

The display control part 323 requests sensory feedback from the real perception processing part 225 according to the processing mode notification (real mode) (step S105). The real perception processing part 225 responds to the display control part 323 with the sensory feedback (the real image RI or the like) of the real world RW in response to the sensory feedback request (step S106). The display control part 323 displays the real image RI which is the sensory feedback of the real world RW on the display 306 (step S107).

The virtual-real switching part 322 notifies the operation command processing part 321 of the processing mode (real mode) (step S104).

### <<Real Mode Sequence>>

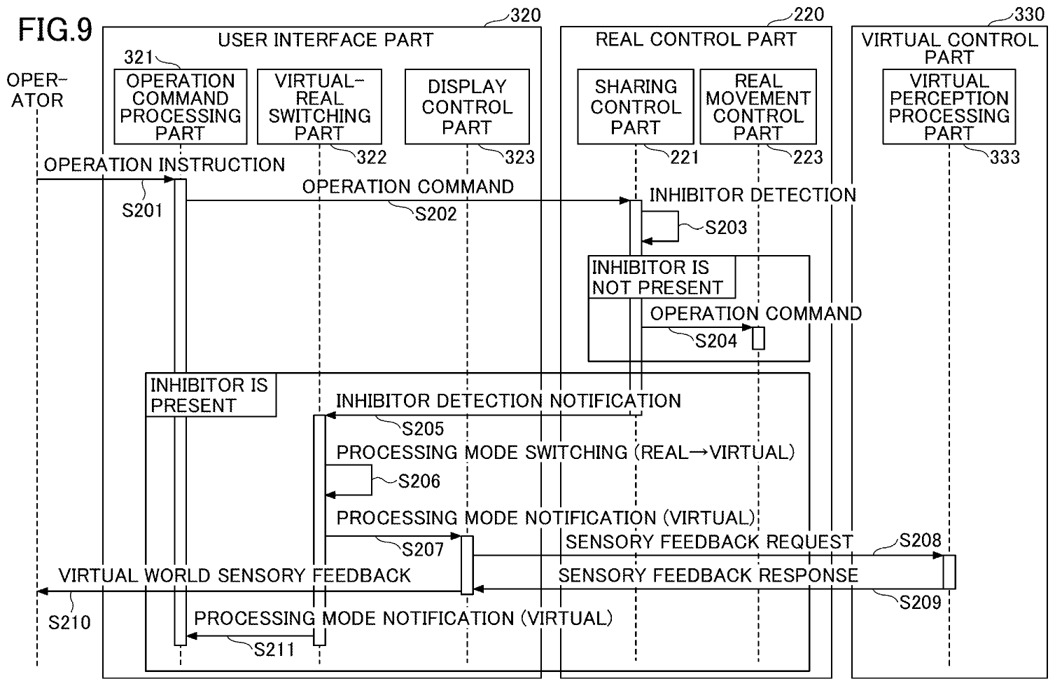

FIG. 9 is a diagram illustrating a real mode sequence example according to the present embodiment. In the real mode, the operator O gives an operation instruction to the user interface part 320 that displays the real image RI (step S201). The operation command processing part 321 transmits the operation command obtained by processing the operation instruction to the sharing control part 221 (step S202). The sharing control part 221 detects an inhibitor OB (a person, an obstacle, or the like) in response to the operation command (step S203).

When there is no inhibitor OB, the sharing control part 221 transmits an operation command to the real movement control part 223 (step S204). The real movement control part 223 controls the actual movement of the autonomous mobile device 200 according to the operation command. When the inhibitor OB is present, the sharing control part 221 sends an inhibitor detection notification to the virtual-real switching part 322 (step S205).

The virtual-real switching part 322 switches from the real mode to the virtual mode in response to the inhibitor detection notification (step S206). The virtual-real switching part 322 notifies the display control part 323 of the processing mode (virtual mode) (step S207).

The display control part 323 requests the virtual perception processing part 333 to provide sensory feedback in response to the processing mode notification (virtual mode) (step S208). The virtual perception processing part 333 responds to the display control part 323 (step S209) with the sensory feedback (a virtual image VI and the like) of the virtual world VW. The display control part 323 displays the virtual image VI which is the sensory feedback of the virtual world VW on the display 306 (step S210).

The virtual-real switching part 322 notifies the operation command processing part 321 of the processing mode (virtual mode) (step S211).

### <<Virtual Mode Sequence>>

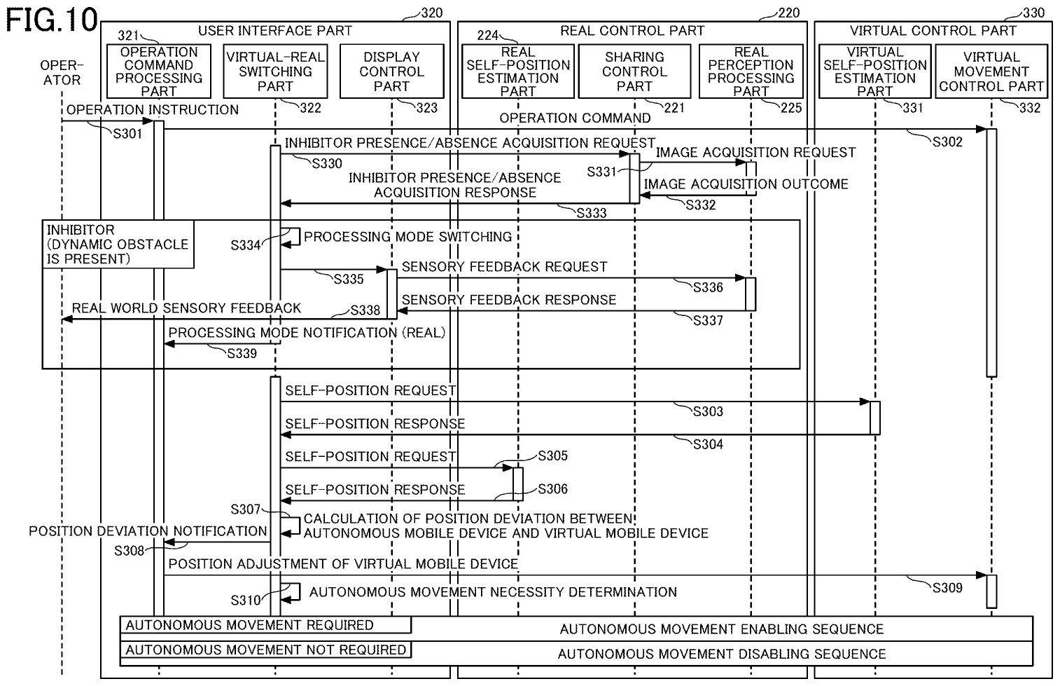

FIG. 10 is a diagram illustrating an example of a virtual mode sequence according to the present embodiment. After switching from the real mode to the virtual mode, the operator O gives an operation instruction to the user interface part 320 that displays a virtual image VI (step S301). The operation command processing part 321 transmits an operation command obtained by processing the operation instruction to the virtual movement control part 332 (step S302). The virtual movement control part 332 controls the movement of the virtual mobile device VM in accordance with the operation command.

The virtual-real switching part 322 requests the sharing control part 221 to obtain the information of the presence or absence of the inhibitor OB that the autonomous mobile device 200 cannot autonomously avoid (step S330). The sharing control part 221 requests the real perception processing part 225 to obtain an image by capturing the inhibitor OB (step S331). The real perception processing part 225 returns the image of the inhibitor OB obtained from the perception sensor 211 such as a camera to the sharing control part 221 (step S332).

The sharing control part 221 detects whether the autonomous movement of the autonomous mobile device 200 is inhibited by the inhibitor OB based on the image in which the inhibitor OB is captured, and sends the information of the presence or absence of the unavoidable inhibitor OB to the virtual-real switching part 322 as an inhibitor detection notification (step S333). When there is an unavoidable inhibitor OB (for example, a dynamic obstacle), the virtual-real switching part 322 switches the processing mode from the virtual mode to the real mode (step S334). When there is no unavoidable inhibitor OB, the virtual-real switching part 322 proceeds to step S303.

When the unavoidable inhibitor OB is present, the virtual-real switching part 322 notifies the display control part 323 of the processing mode (real mode). The display control part 323 requests sensory feedback (a real image RI or the like) from the real perception processing part 225 in response to the processing mode notification (real mode) (step S336). The real perception processing part 225 returns the sensory feedback (the real image RI) of the real world RW to the display control part 323 in response to the sensory feedback request (step S337). The display control part 323 displays the real image RI which is the sensory feedback of the real world RW on the display 306 (step S338). The virtual-real switching part 322 also notifies the operation command processing part 321 of the processing mode (real mode) (step S339). The information processing system 100 then returns to the processing of the real mode sequence illustrated in FIG. 9.

When there is no unavoidable inhibitor OB, the virtual-real switching part 322 requests the virtual self-position estimation part 331 for the information of the position VP of the virtual mobile device VM in the virtual world VW (step S303). The virtual self-position estimation part 331 estimates the position VP of the virtual mobile device VM in the virtual world VW in response to the self-position request, and returns the information of the position VP of the virtual mobile device VM to the virtual-real switching part 322 (step S304).

Further, the virtual-real switching part 322 requests the real self-position estimation part 224 for the information of the position RP of the autonomous mobile device 200 in the real world RW (step S305). The real self-position estimation part 224 estimates the position RP of the autonomous mobile device 200 in the real world RW in response to the self-position request, and returns the information of the position RP of the autonomous mobile device 200 to the virtual-real switching part 322 (step S306).

The virtual-real switching part 322 calculates the position deviation PD between the position RP of the autonomous mobile device 200 and the position VP of the virtual mobile device VM (step S307). The virtual-real switching part 322 notifies the operation command processing part 321 of the position deviation PD between the autonomous mobile device 200 and the virtual mobile device VM (step S308).

The operation command processing part 321 adjusts the position of the virtual mobile device VM to reduce the position deviation PD between the autonomous mobile device 200 and the virtual mobile device VM (step S309). For example, when the virtual mobile device VM travels straight and the autonomous mobile device 200 avoids the inhibitor OB, the virtual mobile device VM travels ahead of the autonomous mobile device 200. Therefore, the operation command processing part 321 adjusts the speed of the virtual mobile device VM to automatically decelerate the position change speed of the virtual mobile device VM.

The virtual-real switching part 322 determines whether autonomous movement of the autonomous mobile device 200 is required (step S310). When the inhibitor OB is present at the position VP of the virtual mobile device VM in the real world RW, the virtual-real switching part 322 determines that the autonomous mobile device 200 is required to autonomously avoid the inhibitor OB. On the other hand, when the inhibitor OB is present on the future trajectory of the virtual mobile device VM in the real world RW, the virtual-real switching part 322 determines that the virtual mode is not required.

The virtual-real switching part 322 shifts to an autonomous movement enabling sequence of the virtual mode when the autonomous movement of the autonomous mobile device 200 is required, and shifts to an autonomous movement disabling sequence of the virtual mode when the virtual mode is not required.

### <<Automatic Movement Enabling/Disabling Sequence>>

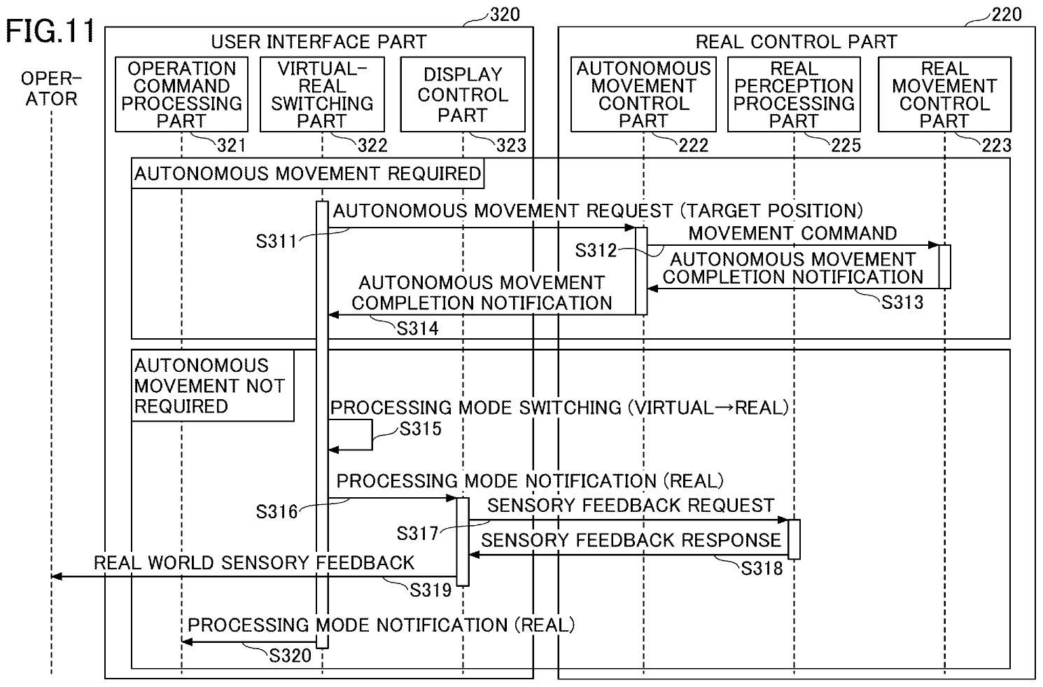

FIG. 11 is a diagram illustrating an example of an autonomous movement enabling/disabling sequence according to the present embodiment. When shifting to the autonomous movement enabling sequence, the virtual-real switching part 322 determines a future trajectory of the virtual mobile device VM according to the operation command and the position of the virtual mobile device VM. The virtual-real switching part 322 also sets a position at which the inhibitor OB disappears on the future trajectory as a sub-target position SP (see FIG. 5).

The virtual-real switching part 322 sends an autonomous movement request (sub-target position SP) for autonomously avoiding the inhibitor OB and moving to the sub-target position SP to the autonomous movement control part 222 (step S311). The autonomous movement control part 222 determines a local moving route MR that avoids the inhibitor OB in response to the autonomous movement request (sub-target position SP). The autonomous movement control part 222 then transmits a movement command (position command or the like) to move along the local moving route MR to the real movement control part 223 (step S312).

In response to the movement command (position command or the like), the real movement control part 223 transmits a movement command (speed command or the like) to the travel control motor driver 208. When the autonomous mobile device 200 reaches the sub-target position SP, the real movement control part 223 sends an autonomous movement completion notification to the autonomous movement control part 222 (step S313). The autonomous movement control part 222 then sends the autonomous movement completion notification to the virtual-real switching part 322 in response to the autonomous movement completion notification (step S314).

The virtual-real switching part 322 switches back from the virtual mode to the real mode in response to the autonomous movement completion notification (step S315). That is, the virtual-real switching part 322 shifts to the autonomous movement disabling sequence of the virtual mode. When it is determined in step S310 in FIG. 10 that the virtual mode is not required, the virtual-real switching part 322 also shifts to the autonomous movement disabling sequence in the virtual mode. In the autonomous movement disabling sequence, after the virtual-real switching part 322 switches back from the virtual mode to the real mode (step S315), the virtual-real switching part 322 notifies the display control part 323 of the processing mode (real mode) (step S316).

The display control part 323 requests sensory feedback from the real perception processing part 225 in response to the processing mode notification (real mode) (step S317). The real perception processing part 225 responds to the display control part 323 with the sensory feedback (the real image RI or the like) of the real world RW in response to the sensory feedback request (step S318). The display control part 323 displays a real image RI which is the sensory feedback of the real world RW on the display 306 (step S319).

The virtual-real switching part 322 notifies the operation command processing part 321 of the processing mode (real mode) (step S320).

Thereafter, the information processing system 100 repeats state transition between the real mode sequence illustrated in FIG. 9 and the virtual mode sequence illustrated in FIG. 10 when the autonomous mobile device 200 detects an inhibitor OB (a person, an obstacle, or the like) that inhibits the operation command.

### Effect of First Embodiment

According to the first embodiment, when the autonomous mobile device 200 detects an inhibitor OB (a person, an obstacle, or the like), the information processing device 300 switches from the real mode to the virtual mode. In the real mode, the autonomous movement AM of the autonomous mobile device 200 in the real world RW is perceived. In the virtual mode, the manual movement MM in response to an operation command of the virtual mobile device VM in the virtual world VW is perceived. Therefore, the information processing device 300 does not make the operator O feel that the autonomous mobile device 200 performs a movement that is different from the instruction of the operator O.

After switching from the real mode to the virtual mode, the operator O can continue the operation without worrying about the collision of the autonomous mobile device 200 with the inhibitor OB. On the other hand, the autonomous mobile device 200 can autonomously avoid the inhibitor OB. After the autonomous mobile device 200 autonomously avoids the inhibitor OB, the information processing device 300 returns from the virtual mode to the real mode, and thus the operator O can continue the operation as if nothing happened. When it is detected that the autonomous movement of the autonomous mobile device 200 is inhibited by the inhibitor OB, the information processing device 300 returns from the virtual mode to the real mode, and thus the operator O can manually avoid the inhibitor OB.

After switching from the real mode to the virtual mode, the information processing device 300 adjusts the position of the virtual mobile device VM so that the position deviation PD between the autonomous mobile device 200 and the virtual mobile device VM becomes small. For example, when the virtual mobile device VM travels straight and the autonomous mobile device 200 avoids the inhibitor OB, it is possible to prevent the virtual mobile device VM from traveling ahead of the autonomous mobile device 200. Therefore, the information processing device 300 does not give the operator O a sense of discomfort when returning from the virtual mode to the real mode.

Further, after switching from the real mode to the virtual mode, when the inhibitor OB is present at the position VP of the virtual mobile device VM in the real world RW, the virtual mobile device VM passes through the inhibitor OB in the virtual world VW. Since the operator O is not aware of the inhibitor OB, the information processing device 300 determines that the autonomous mobile device 200 is required to autonomously avoid the inhibitor OB. Therefore, even if the operator O is not aware of the inhibitor OB, the autonomous mobile device 200 can autonomously avoid the inhibitor OB.

On the other hand, after switching from the real mode to the virtual mode, if the inhibitor OB is present on the future trajectory of the virtual mobile device VM in the real world RW, the inhibitor OB is present in front of the virtual mobile device VM in the virtual mode. Since the operator O becomes aware of the inhibitor OB, the information processing device 300 determines that the virtual mode is not required and returns from the virtual mode to the real mode. Therefore, in the real mode, the autonomous mobile device 200 can avoid the inhibitor OB in response to the operation command of the operator O, or the autonomous mobile device 200 can autonomously avoid the inhibitor OB.

In the virtual mode, the information processing device 300 does not receive sensory feedback (real image RI or the like) of the real world RW from the autonomous mobile device 200. Therefore, in the virtual mode, it is possible to provide a technical improvement of a computer in which a communication delay of the sensory feedback (real image RI or the like) between the information processing device 300 and the autonomous mobile device 200 does not occur.

As described above, in the present embodiment, it is possible to provide a technique in which the operator O remotely operates the autonomous mobile device 200 without a sense of discomfort.

### First Modified Example of First Embodiment

Hereinafter, a first modified example of the first embodiment will be described. When the operator O greatly changes the direction of the virtual mobile device VM after switching from the real mode to the virtual mode, the posture of the virtual mobile device VM greatly differs from the posture of the autonomous mobile device 200. In the first modified example, the virtual-real switching part 322 adjusts the position and the posture of the virtual mobile device VM so that a position deviation PD and a posture deviation AD between the autonomous mobile device 200 and the virtual mobile device VM become small.

### <Functional Configuration>

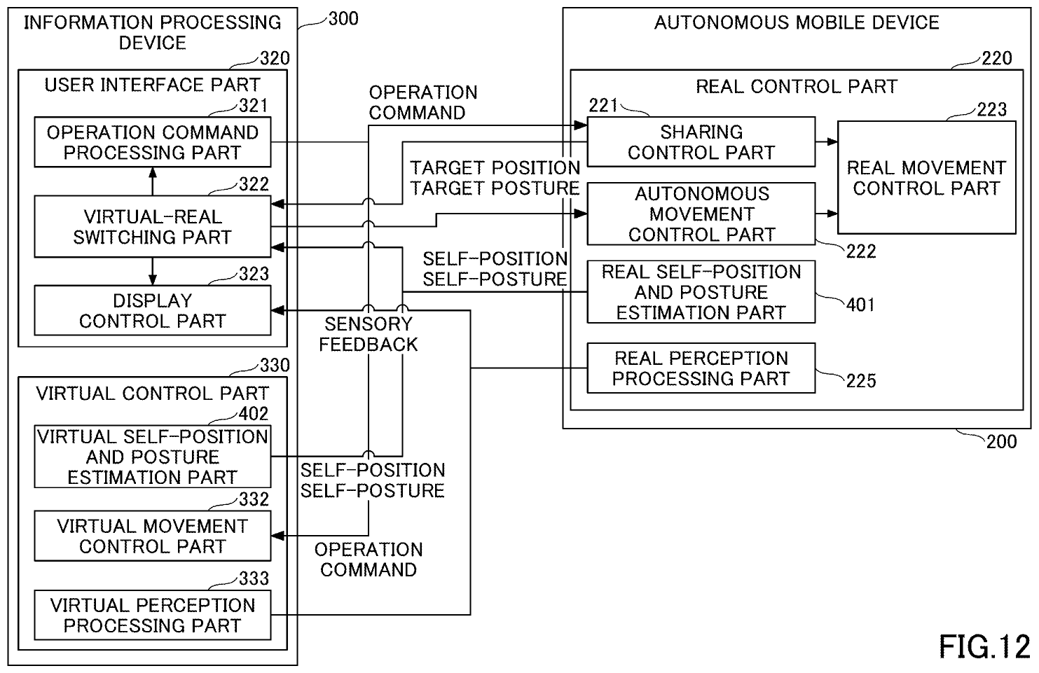

FIG. 12 is a diagram illustrating a modified example of the functional configuration of the information processing system 100 according to the present embodiment. The autonomous mobile device 200 includes a real self-position and posture estimation part 401, and the information processing device 300 includes a virtual self-position and posture estimation part 402.

The real self-position and posture estimation part 401 has a function of estimating a position RP and a posture RA of the autonomous mobile device 200 in the real world RW. The real self-position and posture estimation part 401 estimates the position RP and the posture RA of the autonomous mobile device 200 using the perception sensor 211 such as a LiDAR, a TOF sensor, a MEMS sensor, or an IMU. The position is, for example, a position in three axis (X-axis, Y-axis, and Z-axis) directions in an orthogonal coordinate system, and the posture is, for example, a rotation angle around the three axes (X-axis, Y-axis, and Z-axis) in the orthogonal coordinate system. In response to a self-position and posture request from the virtual-real switching part 322, the real self-position and posture estimation part 401 sends the information of the position RP and the posture RA of the autonomous mobile device 200 to the virtual-real switching part 322.

The virtual self-position and posture estimation part 402 has a function of estimating a position VP and a posture VA of the virtual mobile device VM in the virtual world VW. The virtual self-position and posture estimation part 402 estimates the position VP and the posture VA of the virtual mobile device VM using, for example, an operation command (a forward movement command, a backward movement command, a right pivot-turn command, a left pivot-turn command, an acceleration command, a deceleration command, or the like). In response to a self-position and posture request from the virtual-real switching part 322, the virtual self-position and posture estimation part 402 sends the information of the position VP and the posture VA of the virtual mobile device VM to the virtual-real switching part 322.

The virtual-real switching part 322 receives the information of the position RP and the posture RA of the autonomous mobile device 200 from the real self-position and posture estimation part 401, and receives the information of the position VP and the posture VA of the virtual mobile device VM from the virtual self-position and posture estimation part 402.

The virtual-real switching part 322 adjusts the position of the virtual mobile device VM to reduce the position deviation PD between the position RP of the autonomous mobile device 200 and the position VP of the virtual mobile device VM. For example, the virtual-real switching part 322 adjusts the speed of the virtual mobile device VM and automatically decelerates the position change speed of the virtual mobile device VM. The virtual-real switching part 322 also adjusts the posture of the virtual mobile device VM so that the posture deviation AD between the posture RA of the autonomous mobile device 200 and the posture VA of the virtual mobile device VM becomes small. For example, the virtual-real switching part 322 adjusts the speed of the virtual mobile device VM and automatically decelerates the posture change speed of the virtual mobile device VM.

### <Sequence>

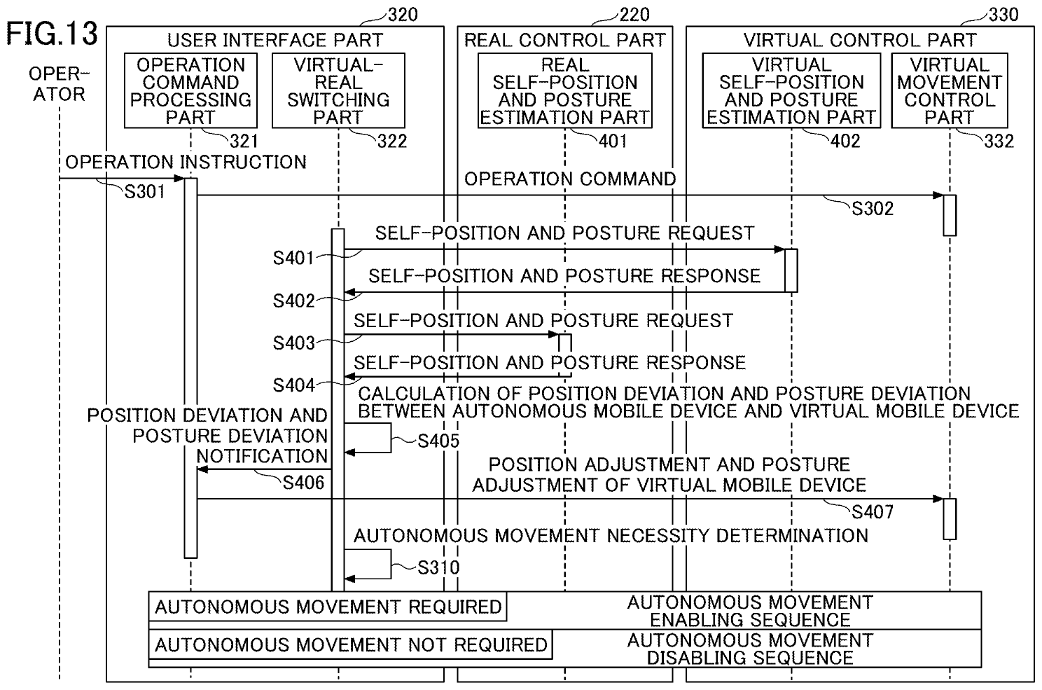

FIG. 13 is a diagram illustrating a modified example of the virtual mode sequence according to the present embodiment. After switching from the real mode to the virtual mode, the virtual-real switching part 322 requests the information of the position VP and the posture VA of the virtual mobile device VM in the virtual world VW from the virtual self-position and posture estimation part 402 (step S401). The virtual self-position and posture estimation part 402 estimates the position VP and the posture VA of the virtual mobile device VM in the virtual world VW in response to the self-position and posture request, and responds to the virtual-real switching part 322 with the information of the position VP and the posture VA of the virtual mobile device VM (step S402).

Further, the virtual-real switching part 322 requests the position RP and the posture RA of the autonomous mobile device 200 in the real world RW from the real self-position and posture estimation part 401 (step S403). The real self-position and posture estimation part 401 estimates the position RP and the posture RA of the autonomous mobile device 200 in the real world RW in response to the self-position and posture request, and responds to the virtual-real switching part 322 with the information of the position RP and the posture PA of the autonomous mobile device 200 (step S404).

The virtual-real switching part 322 calculates a position deviation PD between the position RP of the autonomous mobile device 200 and the position VP of the virtual mobile device VM and a posture deviation AD between the posture RA of the autonomous mobile device 200 and the posture VA of the virtual mobile device VM (step S405). The virtual-real switching part 322 then notifies the operation command processing part 321 of the position deviation PD and the posture deviation AD between the autonomous mobile device 200 and the virtual mobile device VM (step S406).

The operation command processing part 321 performs position adjustment and posture adjustment of the virtual mobile device VM so that the position deviation PD and the posture deviation AD between the autonomous mobile device 200 and the virtual mobile device VM become small (step S407). After the position adjustment and the posture adjustment of the virtual mobile device VM are performed, the operation command processing part 321 automatically decelerates the position and posture change speed of the virtual mobile device VM.

### Effects of First Modified Example

According to the first modified example, after switching from the real mode to the virtual mode, the position adjustment and the posture adjustment of the virtual mobile device VM are performed so that the position deviation PD and the posture deviation AD between the autonomous mobile device 200 and the virtual mobile device VM become small. Therefore, the information processing device 300 does not give the operator O a sense of discomfort when returning from the virtual mode to the real mode.

### Second Modified Example of First Embodiment

Hereinafter, a second modified example of the first embodiment will be described. In the second modified example, after switching from the real mode to the virtual mode, the virtual-real switching part 322 determines whether autonomous movement of the autonomous mobile device 200 in the virtual mode is required using a learned model generated in advance by performing machine learning.

The learning model is generated in advance by performing supervised learning, unsupervised learning, reinforcement learning, or the like. As the learning model, a decision tree, a simple perceptron, a neural network (deep learning), clustering, or the like is used.

For example, when supervised learning is performed, the virtual-real switching part 322 uses a learning data set including state data (input data) that changes from moment to moment and label data (output data) indicating whether the operator O is in a situation of not being aware of the inhibitor OB. The virtual-real switching part 322 generates a learning model indicating the correlation between the input data and the output data in advance. The state data includes the position of the inhibitor OB, the position VP of the virtual mobile device VM, the position RP of the autonomous mobile device 200, and the like, for example.

The virtual-real switching part 322 inputs the state data such as the position of the inhibitor OB, the position VP of the virtual mobile device VM, and the position RP of the autonomous mobile device 200, which change from moment to moment, and determines whether the operator O is in a situation of not being aware of the inhibitor OB using the learned model.

When it is determined that the operator O is not aware of the inhibitor OB, the virtual-real switching part 322 determines that the autonomous mobile device 200 is required to autonomously avoid the inhibitor OB, and requests autonomous movement of the autonomous mobile device 200 from the autonomous movement control part 222.

On the other hand, when it is determined that the operator O is in a situation of being aware of the inhibitor OB, the virtual-real switching part 322 determines that the virtual mode is not required, and returns the virtual mode to the real mode. [Effects of Second Modified Example]

According to the second modified example, by using a learned model obtained by learning state data of all situations, the virtual-real switching part 322 can appropriately determine the necessity of autonomous movement of the autonomous mobile device 200 even in a situation in which it cannot be predicted whether the operator O is in a situation of not being aware of the inhibitor OB. The operator O therefore can operate the autonomous mobile device 200 without feeling uncomfortable.

### Second Embodiment

Hereinafter, the information processing system 100 according to the second embodiment will be described. In the second embodiment, a technique for preventing the operator O from feeling the autonomous movement of a robot arm 510 by switching from the real mode to the virtual mode is provided.

### <System Configuration>

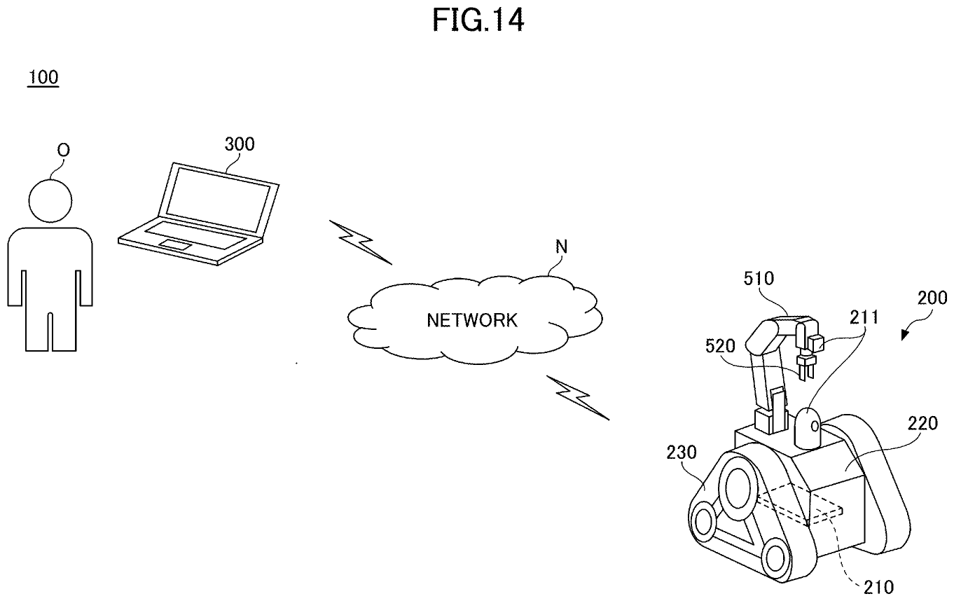

FIG. 14 is a diagram illustrating a system configuration example of the information processing system 100 according to the second embodiment.

The autonomous mobile device 200 includes the robot arm 510 and an end effector 520. The robot arm 510 is, for example, a six-axis articulated robot, and includes a base portion, a trunk portion, an upper arm portion, a forearm portion, and a three-axis wrist portion in this order from the bottom of the arm robot. The base portion of the robot arm 510 is fixed to, for example, the main body 240 of the autonomous mobile device 200. The robot arm 510 includes arm control motors for a first axis to a sixth axis that drive the joint units. The robot arm 510 is not limited to an articulated robot and may be a robot of another type such as a parallel link robot.

The end effector 520 attached to a wrist of the robot arm 510 is detachable. The end effector 520 is, for example, a hand of a multi-fingered gripping type, a vacuum suction type, a magnetic suction type, or the like. The end effector 520 includes an end effector control motor that drives, for example, fingers of a hand or a vacuum pump. The perception sensor 211 (for example, a camera) may be mounted proximate to the end effector 520. Note that the end effector 520 is not limited to a hand and may include a welding tool, a laser processing tool, a fastening tool, or a tool changer for arbitrarily changing these tools.

The robot arm 510 and the end effector 520 are electrically connected to the control unit 210. The control unit 210 controls the arm control motors of the first axis to the sixth axis and the end effector control motor. The robot arm 510 and the end effector 520 autonomously move along a moving route corresponding to a target position and a target posture of the robot arm 510 set in advance. The position and posture of the robot arm 510 are the position and posture of a tool coordinate system fixed to the end effector 520 in a reference coordinate system fixed to the base portion or the like of the robot arm 510.

The information processing device 300 remotely controls the movement of the robot arm 510 and the end effector 520 mounted on the autonomous mobile device 200 in addition to the movement of the traveling units 230 of the autonomous mobile device 200. The information processing device 300 transmits an operation command obtained by processing an operation instruction from the operator O to the autonomous mobile device 200.

### <Hardware Configuration>

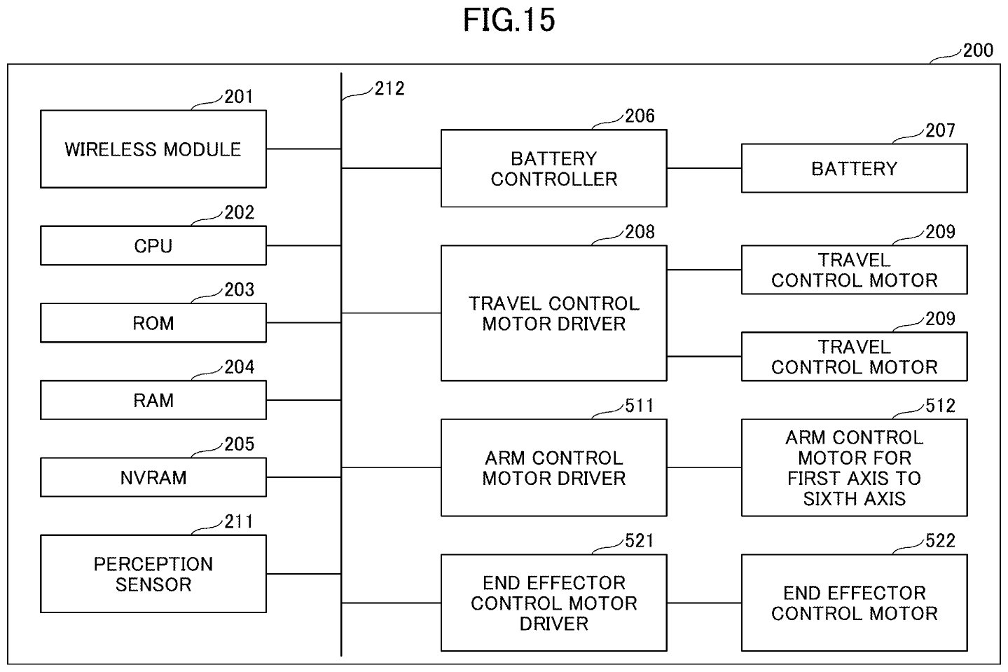

FIG. 15 is a diagram illustrating a hardware configuration example of the autonomous mobile device 200 according to the second embodiment.

The autonomous mobile device 200 further includes an arm control motor driver 511, first axis to sixth axis arm control motors 512, an end effector control motor driver 521, and an end effector control motor 522.

The CPU 202 determines each movement command (a position command, a speed command, and the like) for the first axis to sixth axis arm control motors 512 based on the target position and the target posture of the robot arm 510 using inverse kinematics. The CPU 202 transmits each movement command (a position command and a speed command) for the first axis to sixth axis arm control motors 512 to the arm control motor driver 511.

The arm control motor driver 511 generates various motor drive signals according to each movement command (a position command and a speed command) from the CPU 202, and supplies each motor drive signal to the corresponding arm control motor of the first axis to sixth axis arm control motors 512. The first axis to sixth axis arm control motors 512 rotate in accordance with the respective motor drive signals, and send driving forces to the respective joint units of the robot arm 510.

The arm control motor 512 includes a motor encoder that detects a rotation angle, a rotation speed, and the like of the arm control motor 512. The arm control motor driver 511 controls feedback of the arm control motor 512 according to the rotation angle, the rotation speed, and the like detected by the motor encoder.

The CPU 202 transmits a movement command (a position command, a speed command, and the like) for the end effector control motor 522 to the end effector control motor driver 521.

The end effector control motor driver 521 generates a motor drive signal according to the movement command (a position command, a speed command, and the like) from the CPU 202, and transmits the motor drive signal to the end effector control motor 522. The end effector control motor 522 rotates in response to the motor drive signal, and transmits a driving force to fingers of a hand, a vacuum pump, or the like.

The end effector control motor 522 includes a motor encoder that detects a rotation angle, a rotation speed, and the like of the end effector control motor 522. The end effector control motor driver 521 controls feedback of the end effector control motor 522 according to the rotation angle, the rotation speed, and the like detected by the motor encoder.

### <User Interface>

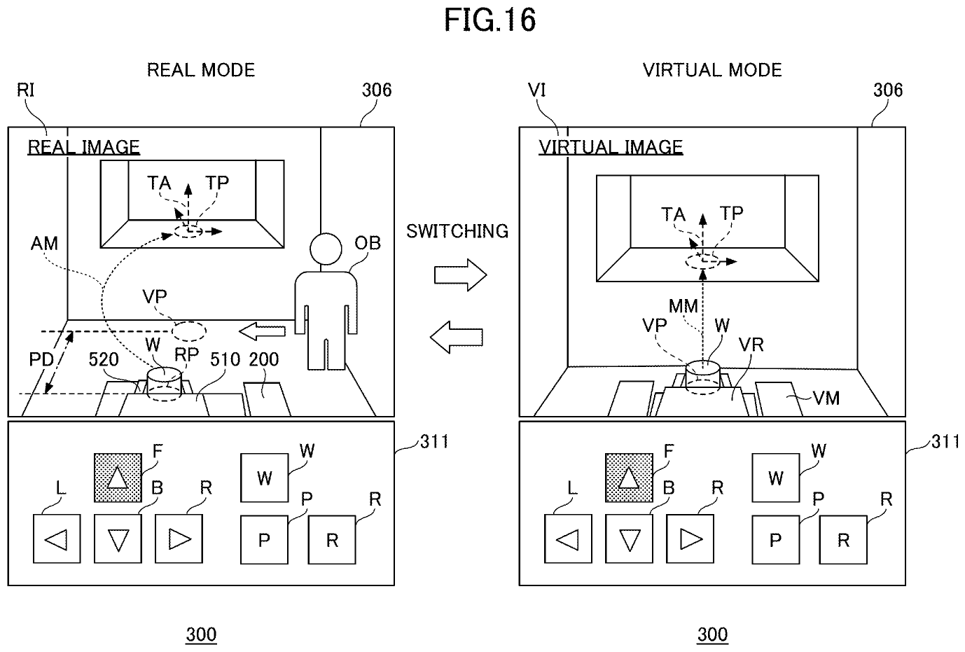

The user interface of the information processing device 300 will be described below. FIG. 16 is a diagram illustrating a user interface example of the information processing device 300 according to the present embodiment.

The information processing device 300 has a processing mode switching function for switching between a real mode and a virtual mode. The real mode is a processing mode provided for the operator O with sensory feedback for perceiving the movement of the robot arm 510 that is present in the real world RW. The virtual mode is a processing mode provided for the operator O with sensory feedback for perceiving the movement of a virtual robot arm VR simulating the robot arm 510, the virtual robot arm VR being present in the virtual world VW simulating the real world RW.

The information processing device 300 includes the user interface part 320. The user interface part 320 assigns operation instructions (movement instructions) for the robot arm 510 or the virtual robot arm VR to various keys of the keyboard 311 of the information processing device 300. For example, the user interface part 320 assigns a forward instruction to an up arrow key F, and a backward instruction to a down arrow key B. The user interface part 320 further assigns right movement to a right arrow key R, and left movement to a left arrow key L. The user interface part 320 further assigns an instruction to rotate the wrist about a W-axis to a W-key W, an instruction to rotate the wrist about a P-axis to a P-key P, and an instruction to rotate the wrist about a R-axis to a R-key R.

The robot arm 510 autonomously moves to a target position TP and a target posture TA of the robot arm 510 along the moving route set in advance. In this example, after the robot arm 510 reaches the target position TP and the target posture TA, the end effector 520 drops off a workpiece WP at the target position TP.

When the robot arm 510 detects an inhibitor OB (for example, a moving person) using the perception sensor 211 (for example, a camera), the user interface part 320 switches from the real mode to the virtual mode. In the real mode, the operator O perceives the autonomous movement AM of the robot arm 510 in the real world RW. However, in the virtual mode, the operator O perceives the manual movement MM in response to the operation command of the virtual robot arm VR in the virtual world VW. Therefore, in the virtual mode, the operator O does not feel that the robot arm 510 performs an autonomous movement AM that is different from the manual movement MM according to the instruction of the operator O.

After switching from the real mode to the virtual mode, the user interface part 320 automatically decelerates the position and posture change speed of the manual movement MM of the virtual robot arm VR so that the position deviation PD and the posture deviation AD between the robot arm 510 and the virtual robot arm VR become small.

When the inhibitor OB is present at the position VP of the virtual robot arm VR in the real world RW, the virtual robot arm VR passes through the inhibitor OB in the virtual world VW, and thus the operator O does not notice the inhibitor OB. Therefore, the information processing device 300 requests the autonomous movement to move to the target position TP and the target posture TA from the robot arm 510 while autonomously avoiding the inhibitor OB.

The robot arm 510 determines a moving route that avoids the inhibitor OB from the position RP of the robot arm 510 to the target position TP and the target posture TA, performs the autonomous movement AM along the moving route, and moves to a sub-target position SP. When the robot arm 510 avoids the inhibitor OB and reaches the target position TP, the information processing device 300 returns from the virtual mode to the real mode.

### Effects of Second Embodiment

According to the second embodiment, when the robot arm 510 detects an inhibitor OB (a person, an obstacle, or the like), the information processing device 300 switches from the real mode to the virtual mode. In the real mode, the operator perceives the autonomous movement AM of the robot arm 510 in the real world RW, but, in the virtual mode, the operator O perceives the manual movement MM of the virtual robot arm VR in the virtual world VW. The information processing device 300 therefore does not make the operator O feel that the robot arm 510 performs a movement that is different from the instruction from the operator O.

After switching from the real mode to the virtual mode, the operator O can continue the operation without worrying about the collision of the robot arm 510 with the inhibitor OB, and the robot arm 510 can autonomously avoid the inhibitor OB. After the robot arm 510 autonomously avoids the inhibitor OB, the information processing device 300 returns from the virtual mode to the real mode. Therefore, the operator O can continue the operation as if nothing happened.

After switching from the real mode to the virtual mode, the information processing device 300 performs position adjustment and posture adjustment of the virtual robot arm VR so that a position deviation PD and a posture deviation AD between the robot arm 510 and the virtual robot arm VR become small. For example, when the virtual robot arm VR moves straight and the robot arm 510 avoids the inhibitor OB, it is possible to prevent the virtual robot arm VR from moving ahead of the robot arm 510. Therefore, the information processing device 300 does not give the operator O a sense of discomfort when returning from the virtual mode to the real mode.

Further, after switching from the real mode to the virtual mode, when the inhibitor OB is present at the position VP of the virtual robot arm VR in the real world RW, the virtual robot arm VR passes through the inhibitor OB in the virtual world VW. Therefore, the information processing device 300 determines that the robot arm 510 is required to autonomously avoid the inhibitor OB. Therefore, even if the operator O is not aware of the inhibitor OB, the robot arm 510 can autonomously avoid the inhibitor OB.

Furthermore, in the virtual mode, the information processing device 300 does not receive sensory feedback (a real image RI or the like) of the real world RW from the robot arm 510. Therefore, it is possible to provide a technical improvement of a computer in which a communication delay of sensory feedback (a real image RI or the like) between the information processing device 300 and the autonomous mobile device 200 does not occur.

The various functions of the embodiments described above can be implemented by one or more process circuits. Here, the “process circuit” in this specification includes a processor that is programmed by software to perform the functions, such as a processor implemented by an electronic circuit. Alternatively, the “process circuit” includes a device such as an ASIC (Application Specific Integrated Circuit) or a DSP (Digital Signal Processor) designed to perform the functions. Further, the “process circuit” includes a device such as a FPGA (field programmable gate array) or a conventional circuit module.

The present disclosure has, for example, the following aspects:

<1> An information processing device for communicating with an autonomous mobile device, the information processing device including: circuitry; and a memory storing computer-executable instructions that cause the circuitry to execute: transmitting an operation command of an operator of the autonomous mobile device to the autonomous mobile device existing in a real world and a virtual mobile device simulating the autonomous mobile device and existing in a virtual world simulating the real world; and switching from a real mode to a virtual mode when the autonomous mobile device detects an inhibitor inhibiting operability of the operator to operate the autonomous mobile device, the real mode providing the operator with sensory feedback corresponding to an autonomous movement of the autonomous mobile device in the real world, and the virtual mode providing the operator with sensory feedback corresponding to a movement according to the operation command of the virtual mobile device in the virtual world.

<2> The information processing device according to above <1>, wherein after switching from the real mode to the virtual mode, the circuitry is caused to execute switching from the virtual mode to the real mode after the autonomous mobile device autonomously avoids the inhibitor.

<3> The information processing device according to above <1> or <2>, wherein after switching from the real mode to the virtual mode, the circuitry is further caused to execute controlling the movement of the virtual mobile device in accordance with the operation command.

<4> The information processing device according to any one of above <1> to <3>, wherein after switching from the real mode to the virtual mode, in order to reduce at least one of a position deviation and a posture deviation between the autonomous mobile device and the virtual mobile device, the circuitry is caused to execute adjusting a corresponding one of a position and a posture of the virtual mobile device.

<5> The information processing device according to any one of above <1> to <4>, wherein after switching from the real mode to the virtual mode, when the inhibitor is present at the position of the virtual mobile device in the real world, the circuitry is caused to execute determining that the autonomous mobile device is required to autonomously avoid the inhibitor and requesting the autonomous mobile device to perform an autonomous movement for autonomously avoiding the inhibitor.

<6> The information processing device according to any one of above <1> to <5>, wherein after switching from the real mode to the virtual mode, when the inhibitor is present on a future trajectory of the virtual mobile device in the real world, the circuitry is caused to execute determining that the autonomous mobile device is not required to autonomously avoid the inhibitor and switching from the virtual mode to the real mode.

<7> The information processing device according to any one of above <1> to <6>, wherein after switching from the real mode to the virtual mode, the circuitry is caused to execute determining a future trajectory of the virtual mobile device in accordance with the operation command and at least one of the position and the posture of the virtual mobile device, setting a position where the inhibitor is not present on the future trajectory as a target position, and requesting the autonomous mobile device to perform an autonomous movement for moving to the target position while autonomously avoiding the inhibitor.

<8> The information processing device according to any one of above <1> to <7>, wherein after switching from the real mode to the virtual mode, when the autonomous mobile device detects that the autonomous movement is inhibited by the inhibitor in the real world or when the autonomous mobile device detects that the autonomous movement is inhibited by another inhibitor different from the inhibitor, the circuitry is caused to execute switching from the virtual mode to the real mode.

<9> An information processing system including an autonomous mobile device and an information processing device for communicating with the autonomous mobile device, the information processing system including:
circuitry; and
a memory storing computer-executable instructions that cause the circuitry to execute:
controlling a movement of the autonomous mobile device in response to an operation command of an operator of the autonomous mobile device and an autonomous movement request;
transmitting the operation command to the autonomous mobile device existing in a real world and a virtual mobile device existing in a virtual world simulating the real world and simulating the autonomous mobile device; and
switching from a real mode to a virtual mode when the autonomous mobile device detects an inhibitor inhibiting operability of the operator to operate the autonomous mobile device, the real mode providing the operator with sensory feedback corresponding to a movement of the autonomous mobile device in the real world, and the virtual mode providing the operator with sensory feedback corresponding to a movement according to the operation command of the virtual mobile device in the virtual world.

<10> An information processing method performed by an information processing device for communicating with an autonomous mobile device, the information processing method including:
transmitting an operation command of an operator of the autonomous mobile device to the autonomous mobile device existing in a real world and a virtual mobile device existing in a virtual world simulating the real world and simulating the autonomous mobile device; and
switching from a real mode to a virtual mode when the autonomous mobile device detects an inhibitor inhibiting operability of the operator to operate the autonomous mobile device, the real mode providing the operator with sensory feedback corresponding to an autonomous movement of the autonomous mobile device in the real world, and the virtual mode providing the operator with sensory feedback corresponding to a movement according to the operation command of the virtual mobile device in the virtual world.

<11> A non-transitory recording medium storing computer-executable instructions that cause circuitry of an information processing device for communicating with an autonomous mobile device to execute:
transmitting an operation command of an operator of the autonomous mobile device to the autonomous mobile device existing in a real world and a virtual mobile device existing in a virtual world simulating the real world and simulating the autonomous mobile device; and
switching from a real mode to a virtual mode when the autonomous mobile device detects an inhibitor inhibiting operability of the operator to operate the autonomous mobile device, the real mode providing the operator with sensory feedback corresponding to an autonomous movement of the autonomous mobile device in the real world, and the virtual mode providing the operator with sensory feedback corresponding to a movement according to the operation command of the virtual mobile device in the virtual world.

According to the present disclosure, it is possible to provide a technique in which an operator who operates an autonomous mobile device performs a desired operation without feeling uncomfortable with feedback corresponding to the operation.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general-purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device, or solid-state memory device.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory for storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. An information processing device for communicating with an autonomous mobile device, the information processing device comprising:
circuitry; and
a memory storing computer-executable instructions that cause the circuitry to execute:
transmitting an operation command of an operator of the autonomous mobile device to the autonomous mobile device existing in a real world and a virtual mobile device simulating the autonomous mobile device and existing in a virtual world simulating the real world; and
switching from a real mode to a virtual mode when the autonomous mobile device detects an inhibitor inhibiting operability of the operator to operate the autonomous mobile device, the real mode providing the operator with sensory feedback corresponding to an autonomous movement of the autonomous mobile device in the real world, and the virtual mode providing the operator with sensory feedback corresponding to a movement according to the operation command of the virtual mobile device in the virtual world.

2. The information processing device according to claim 1, wherein after switching from the real mode to the virtual mode, the circuitry is caused to execute switching from the virtual mode to the real mode after the autonomous mobile device autonomously avoids the inhibitor.

3. The information processing device according to claim 1, wherein after switching from the real mode to the virtual mode, the circuitry is caused to execute controlling the movement of the virtual mobile device in accordance with the operation command.

4. The information processing device according to claim 1, wherein after switching from the real mode to the virtual mode, in order to reduce at least one of a position deviation and a posture deviation between the autonomous mobile device and the virtual mobile device, the circuitry is caused to execute adjusting a corresponding one of a position and a posture of the virtual mobile device.

5. The information processing device according to claim 1, wherein after switching from the real mode to the virtual mode, when the inhibitor is present at a position of the virtual mobile device in the real world, the circuitry is caused to execute determining that the autonomous mobile device is required to autonomously avoid the inhibitor and requesting the autonomous mobile device to perform an autonomous movement for autonomously avoiding the inhibitor.

6. The information processing device according to claim 1, wherein after switching from the real mode to the virtual mode, when the inhibitor is present on a future trajectory of the virtual mobile device in the real world, the circuitry is caused to execute determining that the autonomous mobile device is not required to autonomously avoid the inhibitor and switching from the virtual mode to the real mode.

7. The information processing device according to claim 1, wherein after switching from the real mode to the virtual mode, the circuitry is caused to execute determining a future trajectory of the virtual mobile device in accordance with the operation command and at least one of a position and a posture of the virtual mobile device, setting a position where the inhibitor is not present on the future trajectory as a target position, and requesting the autonomous mobile device to perform an autonomous movement for moving to the target position while autonomously avoiding the inhibitor.

8. The information processing device according to claim 1, wherein after switching from the real mode to the virtual mode, when the autonomous mobile device detects that the autonomous movement is inhibited by the inhibitor in the real world or when the autonomous mobile device detects that the autonomous movement is inhibited by another inhibitor different from the inhibitor, the circuitry is caused to execute switching from the virtual mode to the real mode.

9. An information processing system including an autonomous mobile device and an information processing device for communicating with the autonomous mobile device, the information processing system including:
circuitry; and
a memory storing computer-executable instructions that cause the circuitry to execute:
controlling an operation of the autonomous mobile device in response to an operation command of an operator of the autonomous mobile device to the autonomous mobile device and an autonomous movement request;
transmitting the operation command to the autonomous mobile device existing in a real world and a virtual mobile device existing in a virtual world simulating the real world and simulating the autonomous mobile device; and
switching from a real mode to a virtual mode when the autonomous mobile device detects an inhibitor inhibiting operability of the operator to operate the autonomous mobile device, the real mode providing the operator with sensory feedback corresponding to a movement of the autonomous mobile device in the real world, and the virtual mode providing the operator with sensory feedback corresponding to a movement according to the operation command of the virtual mobile device in the virtual world.

10. A non-transitory recording medium storing computer-executable instructions that cause circuitry of an information processing device for communicating with an autonomous mobile device to execute:
transmitting an operation command of an operator of the autonomous mobile device to the autonomous mobile device existing in a real world and a virtual mobile device existing in a virtual world simulating the real world and simulating the autonomous mobile device; and
switching from a real mode to a virtual mode when the autonomous mobile device detects an inhibitor inhibiting operability of the operator to operate the autonomous mobile device, the real mode providing the operator with sensory feedback corresponding to an autonomous movement of the autonomous mobile device in the real world, and the virtual mode providing the operator with sensory feedback corresponding to a movement according to the operation command of the virtual mobile device in the virtual world.
